(19) United States
(12) Patent Application Publication
(10) Pub. No.: US 2026/0032477 A1
(43) Pub. Date: Jan. 29, 2026

(54) BEAM PAIR INFORMATION REPORTING

(71) Applicant: QUALCOMM Incorporated, San Diego, CA (US)

(72) Inventors: Qiaoyu LI, Beijing (CN); Hamed PEZESHKI, San Diego, CA (US); Mahmoud TAHERZADEH BOROUJENI, San Diego, CA (US); Arumugam CHENDAMARAI KANNAN, San Diego, CA (US); Mohamed Fouad Ahmed MARZBAN, San Diego, CA (US)

(21) Appl. No.: 19/145,479

(22) PCT Filed: Feb. 15, 2023
(86) PCT No.: PCT/CN2023/076100

§ 371 Date: Jul. 2, 2025

(51) Int. Cl. H04W 24/08; H04B 7/06

(52) U.S. Cl. CPC H04W 24/08; H04B 7/0695

(57) ABSTRACT

Methods, systems, and devices for wireless communication are described. A user equipment may transmit a report that indicates receive beam information for the UE, where a first dimension of the report is associated with one or more transmission resources of a network entity and a second dimension of the report is associated with one or more receive beam pointing directions at the UE. The UE may receive, from a network entity, an indication of a first receive beam pointing direction of the one or more receive beam pointing directions for a downlink message for the UE based on the report, where the first receive beam pointing direction is associated with a first transmission resource. The UE may receive the downlink message using a receive beam associated with the first receive beam pointing direction based on the received indication from the network entity.

### CROSS REFERENCE

This application is a 371 National Stage of PCT Application No. PCT/CN2023/076100, filed on Feb. 15, 2023, entitled “BEAM PAIR INFORMATION REPORTING”, and assigned to the assignee hereof. The disclosure of the prior Application is considered part of and is incorporated by reference into this Patent Application.

### INTRODUCTION

The following relates to wireless communications, and more specifically to managing beam pair information.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). In some cases, the UE may transmit beam information that may disclose proprietary information of the UE and increase overhead.

### SUMMARY

A method for wireless communication at a user equipment (UE) is described. In some examples, the method may include transmitting a report that indicates receive beam information for the UE, a first dimension of the report associated with one or more transmission resources of a network entity, and a second dimension of the report associated with one or more receive beam pointing directions at the UE. In some examples, the method may further include, receiving, based on the report, an indication of a first receive beam pointing direction of the one or more receive beam pointing directions for a downlink message for the UE, the first receive beam pointing direction associated with a first transmission resource of the one or more transmission resources. Further, in some examples, the method may include receiving the downlink message using a receive beam associated with the first receive beam pointing direction based on the indication of the first receive beam pointing direction.

An apparatus for wireless communication at a UE is described. The apparatus may include a processor, memory coupled with the processor, and instructions stored in the memory. The instructions may be executable by the processor to cause the apparatus to transmit a report that indicates receive beam information for the UE, a first dimension of the report associated with one or more transmission resources of a network entity, and a second dimension of the report associated with one or more receive beam pointing directions at the UE. In some examples, the apparatus may receive, based on the report, an indication of a first receive beam pointing direction of the one or more receive beam pointing directions for a downlink message for the UE, the first receive beam pointing direction associated with a first transmission resource of the one or more transmission resources. Further, in some examples, the apparatus may receive the downlink message using a receive beam associated with the first receive beam pointing direction based on the indication of the first receive beam pointing direction.

Another apparatus for wireless communication at a UE is described. In some examples, the apparatus may include means for transmitting a report that indicates receive beam information for the UE, a first dimension of the report associated with one or more transmission resources of a network entity, and a second dimension of the report associated with one or more receive beam pointing directions at the UE. Further, in some examples, the apparatus may have means for receiving, based on the report, an indication of a first receive beam pointing direction of the one or more receive beam pointing directions for a downlink message for the UE, the first receive beam pointing direction associated with a first transmission resource of the one or more transmission resources. Additionally, in some examples, the apparatus may have means for receiving the downlink message using a receive beam associated with the first receive beam pointing direction based on the indication of the first receive beam pointing direction.

A non-transitory computer-readable medium storing code for wireless communication at a UE is described. In some examples, the code may include instructions executable by a processor to transmit a report that indicates receive beam information for the UE, a first dimension of the report associated with one or more transmission resources of a network entity, and a second dimension of the report associated with one or more receive beam pointing directions at the UE. In some examples, the code may also include instructions executable by a processor to receive, based on the report, an indication of a first receive beam pointing direction of the one or more receive beam pointing directions for a downlink message for the UE, the first receive beam pointing direction associated with a first transmission resource of the one or more transmission resources. Further, in some examples, the code may include instructions executable by the processor to receive the downlink message using a receive beam associated with the first receive beam pointing direction based on the indication of the first receive beam pointing direction.

Some examples of the method, apparatuses, and non-transitory computer-readable medium described herein may further include operations, features, means, or instructions for receiving an indication of a total quantity of entries associated with the first dimension of the report and a total quantity of entries associated with the second dimension of the report, where the report may be in accordance with the indication.

In some examples of the method, apparatuses, and non-transitory computer-readable medium described herein, the total quantity of entries associated with the first dimension may be based on one or more channel measurement resources, one or more virtual resources, or a combination thereof.

Some examples of the method, apparatuses, and non-transitory computer-readable medium described herein may further include operations, features, means, or instructions for transmitting an indication of a capability of the UE to report the report, the capability indicating a quantity of entries associated with the second dimension of the report, a quantity of non-zero values associated with the one or more receive beam pointing directions in the report, a quantity of non-zero values associated with the one or more receive beam pointing directions per transmission resource, or a combination thereof.

Some examples of the method, apparatuses, and non-transitory computer-readable medium described herein may further include operations, features, means, or instructions for transmitting one or more non-zero values associated with the one or more receive beam pointing directions in the report, where the one or more non-zero values indicate one or more preferred receive beam pointing directions associated with the one or more transmission resources of the network entity.

Some examples of the method, apparatuses, and non-transitory computer-readable medium described herein may further include operations, features, means, or instructions for transmitting an indication of positions of each of the one or more non-zero values in the report, where the positions may be indicated via one of a bitmap, a combinatorial index, an index associated with each of the one or more receive beam pointing directions, or a combination thereof.

In some examples of the method, apparatuses, and non-transitory computer-readable medium described herein, the one or more non-zero values indicate a beam width associated with the one or more preferred receive beam pointing directions, a beamforming gain associated with the one or more preferred receive beam pointing directions, or both.

In some examples of the method, apparatuses, and non-transitory computer-readable medium described herein, a quantity of non-zero values associated with the one or more receive beam pointing directions may be fixed per transmission resource.

Some examples of the method, apparatuses, and non-transitory computer-readable medium described herein may further include operations, features, means, or instructions for receiving an indication of the quantity of non-zero values associated with the one or more receive beam pointing directions per transmission resource.

In some examples of the method, apparatuses, and non-transitory computer-readable medium described herein, a quantity of non-zero values associated with the one or more receive beam pointing directions may be fixed for the report.

Some examples of the method, apparatuses, and non-transitory computer-readable medium described herein may further include operations, features, means, or instructions for receiving an indication of the quantity of non-zero values associated with the one or more receive beam pointing directions in the report.

Some examples of the method, apparatuses, and non-transitory computer-readable medium described herein may further include operations, features, means, or instructions for transmitting, via a first channel state information (CSI) message, a quantity of the one or more receive beam pointing directions at the UE, a quantity of non-zero values associated with the one or more receive beam pointing directions per transmission resource, a quantity of non-zero values associated with the one or more receive beam pointing directions in the report, or any combination thereof. In some examples, the method may further include transmitting, via a second CSI message and in accordance with the first CSI message, one or more non-zero values in the report, indexes associated with each of the one or more non-zero values, or both, where the one or more non-zero values indicate preferred receive beam pointing directions at the UE associated with transmission resources of the network entity.

Some examples of the method, apparatuses, and non-transitory computer-readable medium described herein may further include operations, features, means, or instructions for receiving, via the indication, a multi-dimensional index associated with the report, where a first dimension of the multi-dimensional index indicates the first transmission resource of the one or more transmission resources of the network entity and a second dimension of the multi-dimensional index indicates the first receive beam pointing direction of the one or more or more receive beam pointing directions at the UE.

Some examples of the method, apparatuses, and non-transitory computer-readable medium described herein may further include operations, features, means, or instructions for transmitting one or more non-zero values associated with the one or more receive beam pointing directions at the UE for a single transmission resource of the network entity based on the one or more non-zero values associated with the one or more receive beam pointing directions being equal for each transmission resource of the one or more transmission resources.

In some examples of the method, apparatuses, and non-transitory computer-readable medium described herein, the indication of the first receive beam pointing direction includes a single dimensional index associated with the report that indicates the first receive beam pointing direction.

In some examples of the method, apparatuses, and non-transitory computer-readable medium described herein, the indication of the first receive beam pointing direction includes a CSI report setting identification, a slot identification associated with a transmission slot of the report, or both.

In some examples of the method, apparatuses, and non-transitory computer-readable medium described herein, the report includes a multi-dimensional report.

A method is described. The method may include obtaining a report that indicates receive beam information for a UE, a first dimension of the report associated with one or more transmission resources of the network entity, and a second dimension of the report associated with one or more receive beam pointing directions for the UE. In some examples, the method may further include, outputting, based on the report, an indication of a first receive beam pointing direction of the one or more receive beam pointing directions for use in a downlink message for the UE, the first receive beam pointing direction associated with a first transmission resource of the one or more transmission resources. In some examples, the method may include outputting the downlink message using the first transmission resource associated with the first receive beam pointing direction based on the indication of the first receive beam pointing direction.

An apparatus is described. The apparatus may include a processor, memory coupled with the processor, and instructions stored in the memory. In some examples, the instructions may be executable by the processor to cause the apparatus to obtain a report that indicates receive beam information for a UE, a first dimension of the report associated with one or more transmission resources of the network entity, and a second dimension of the report associated with one or more receive beam pointing directions for the UE. In some examples, the apparatus may output, based at least in part on the report, an indication of a first receive beam pointing direction of the one or more receive beam pointing directions for use in a downlink message for the UE, the first receive beam pointing direction associated with a first transmission resource of the one or more transmission resources. Further, in some examples, the apparatus may output the downlink message using the first transmission resource associated with the first receive beam pointing direction based on the indication of the first receive beam pointing direction.

Another apparatus is described. In some examples, the apparatus may include means for obtaining a report that indicates receive beam information for a UE, a first dimension of the report associated with one or more transmission resources of the network entity, and a second dimension of the report associated with one or more receive beam pointing directions for the UE. In some examples, the apparatus may include means for outputting, based on the report, an indication of a first receive beam pointing direction of the one or more receive beam pointing directions for use in a downlink message for the UE, the first receive beam pointing direction associated with a first transmission resource of the one or more transmission resources. In some examples, the apparatus may include means for outputting the downlink message using the first transmission resource associated with the first receive beam pointing direction based on the indication of the first receive beam pointing direction.

A non-transitory computer-readable medium storing code is described. In some examples, the code may include instructions executable by a processor to obtain a report that indicates receive beam information for a UE, a first dimension of the report associated with one or more transmission resources of the network entity, and a second dimension of the report associated with one or more receive beam pointing directions for the UE. IN some examples, the code may include instructions executable by the processor to output, base at least in part on the report, an indication of a first receive beam pointing direction of the one or more receive beam pointing directions for use in a downlink message for the UE, the first receive beam pointing direction associated with a first transmission resource of the one or more transmission resources. In some example, the code may include instructions executable by the processor to output the downlink message using the first transmission resource associated with the first receive beam pointing direction based on the indication of the first receive beam pointing direction.

Some examples of the method, apparatuses, and non-transitory computer-readable medium described herein may further include operations, features, means, or instructions for obtaining the first receive beam pointing direction based on a beam prediction procedure and on the report, where the outputted indication of the first receive beam pointing direction may be in accordance with the obtained first receive beam pointing direction.

In some examples of the method, apparatuses, and non-transitory computer-readable medium described herein, the beam prediction procedure may be based on a machine learning model.

Some examples of the method, apparatuses, and non-transitory computer-readable medium described herein may further include operations, features, means, or instructions for outputting an indication of a total quantity of entries associated with the first dimension of the report and a total quantity of entries associated with the second dimension of the report, where the report may be in accordance with the indication.

In some examples of the method, apparatuses, and non-transitory computer-readable medium described herein, the total quantity of entries associated with the first dimension may be based on one or more channel measurement resources, one or more virtual resources, or a combination thereof.

Some examples of the method, apparatuses, and non-transitory computer-readable medium described herein may further include operations, features, means, or instructions for obtaining an indication of a capability of the UE to report the report, where the capability indicates a quantity of entries associated with the second dimension of the report, a quantity of non-zero values associated with the one or more receive beam pointing directions in the report, a quantity of non-zero values associated with the one or more receive beam pointing directions per transmission resource, or a combination thereof.

Some examples of the method, apparatuses, and non-transitory computer-readable medium described herein may further include operations, features, means, or instructions for obtaining one or more non-zero values associated with the one or more receive beam pointing directions in the report, where the one or more non-zero values indicate one or more preferred receive beam pointing directions associated with the one or more transmission resources of the network entity.

Some examples of the method, apparatuses, and non-transitory computer-readable medium described herein may further include operations, features, means, or instructions for obtaining an indication of positions of each of the one or more non-zero values in the report, where the positions may be indicated via one of a bitmap, a combinatorial index, an index associated with each of the one or more receive beam pointing directions, or a combination thereof.

In some examples of the method, apparatuses, and non-transitory computer-readable medium described herein, the one or more non-zero values indicate a beam width associated with the one or more preferred receive beam pointing directions, a beamforming gain associated with the one or more preferred receive beam pointing directions, or both.

In some examples of the method, apparatuses, and non-transitory computer-readable medium described herein, a quantity of non-zero values associated with the one or more receive beam pointing directions may be fixed per transmission resource.

Some examples of the method, apparatuses, and non-transitory computer-readable medium described herein may further include operations, features, means, or instructions for outputting an indication of the quantity of non-zero values associated with the one or more receive beam pointing directions per transmission resource.

In some examples of the method, apparatuses, and non-transitory computer-readable medium described herein, a quantity of non-zero values associated with the one or more receive beam pointing directions may be fixed for the report.

Some examples of the method, apparatuses, and non-transitory computer-readable medium described herein may further include operations, features, means, or instructions for outputting an indication of the quantity of non-zero values associated with the one or more receive beam pointing directions in the report.

Some examples of the method, apparatuses, and non-transitory computer-readable medium described herein may further include operations, features, means, or instructions for obtaining, via a first CSI message, a quantity of the one or more receive beam pointing directions at the UE, a quantity of non-zero values associated with the one or more receive beam pointing directions per transmission resource, a quantity of non-zero values associated with the one or more receive beam pointing directions in the report, or any combination thereof. In some examples, the method, apparatuses, and non-transitory computer-readable medium may include obtaining, via a second CSI message and in accordance with the first CSI message, one or more non-zero values in the report, indexes associated with each of the one or more non-zero values, or both, where the one or more non-zero values indicate one or more preferred receive beam pointing directions at the UE associated with transmission resources of the network entity.

In some examples of the method, apparatuses, and non-transitory computer-readable medium described herein, outputting, via the indication, a multi-dimensional index associated with the report, where a first dimension of the multi-dimensional index indicates the first transmission resource of the one or more transmission resources of the network entity and a second dimension of the multi-dimensional index indicates the first receive beam pointing direction of the one or more or more receive beam pointing directions at the UE.

Some examples of the method, apparatuses, and non-transitory computer-readable medium described herein may further include operations, features, means, or instructions for obtaining one or more non-zero values associated with the one or more receive beam pointing directions at the UE for a single transmission resource of the network entity based on the one or more non-zero values associated with the one or more receive beam pointing directions being equal for each transmission resource of the one or more transmission resources.

In some examples of the method, apparatuses, and non-transitory computer-readable medium described herein, the indication of the first receive beam pointing direction includes a single dimensional index associated with the report that indicates the first receive beam pointing direction.

In some examples of the method, apparatuses, and non-transitory computer-readable medium described herein, the indication of the first receive beam pointing direction includes a CSI report setting identification, a slot identification associated with a transmission slot of the report, or both.

In some examples of the method, apparatuses, and non-transitory computer-readable medium described herein, the report includes a multi-dimensional report.

### BRIEF DESCRIPTION OF THE DRAWINGS

FIG. 1 illustrates an example of a wireless communications system that supports beam pair information reporting in accordance with one or more aspects of the present disclosure.

FIG. 2 illustrates an example of a network architecture that supports beam pair information reporting in accordance with one or more aspects of the present disclosure.

FIG. 3 illustrates an example of a wireless communications system that supports beam pair information reporting in accordance with one or more aspects of the present disclosure.

FIGS. 4A and 4B illustrate examples of report diagrams that support beam pair information reporting in accordance with one or more aspects of the present disclosure.

FIG. 5 illustrates an example of a report that supports beam pair information reporting in accordance with one or more aspects of the present disclosure.

FIG. 6 illustrates an example of a machine learning diagram that supports beam pair information reporting in accordance with one or more aspects of the present disclosure.

FIG. 7 illustrates an example of a process flow that supports beam pair information reporting in accordance with one or more aspects of the present disclosure.

FIGS. 8 and 9 illustrate block diagrams of devices that support beam pair information reporting in accordance with one or more aspects of the present disclosure.

FIG. 10 illustrates a block diagram of a communications manager that supports beam pair information reporting in accordance with one or more aspects of the present disclosure.

FIG. 11 illustrates a diagram of a system including a device that supports beam pair information reporting in accordance with one or more aspects of the present disclosure.

FIGS. 12 and 13 illustrate block diagrams of devices that support beam pair information reporting in accordance with one or more aspects of the present disclosure.

FIG. 14 illustrates a block diagram of a communications manager that supports beam pair information reporting in accordance with one or more aspects of the present disclosure.

FIG. 15 illustrates a diagram of a system including a device that supports beam pair information reporting in accordance with one or more aspects of the present disclosure.

FIGS. 16 through 19 illustrate flowcharts showing methods that support beam pair information reporting in accordance with one or more aspects of the present disclosure.

### DETAILED DESCRIPTION

In some wireless communications systems, a network entity may perform beam pair prediction to predict a pairing between (or pair of) a transmission beam (e.g., associated with a transmission resource) of the network entity and a receive beam (e.g., associated with a transmission configuration indicator (TCI) state) of a user equipment (UE). For example, the network entity 105 may obtain one or more measurements associated with spatially down-sampled measurements of beam pairs from the UE 115. The network entity 105 may use the measurements in order to predict the measurements of other beam pairs via artificial intelligence or a machine learning model. In order to facilitate beam pair prediction at the network entity, the UE may transmit, to the network entity, receive beam information (e.g., UE receive beam information) including the direction associated with each receive beam at the UE, the width of each receive beam at the UE, or other information. The network entity may receive and use this receive beam information associated with each UE receive beam to predict beam pairs and transmit, to the UE, an indication of which one or more receive beams the UE is to use or which beam pair or pairs (e.g., a pair of a UE receive beam and a network entity transmit beam) to use for subsequent communications. For example, the network entity may transmit an indication of a respective beam identifier, a respective beam direction, or both, of a receive beam of the UE or a transmission beam (e.g., or a transmission resource that corresponds to the network entity transmission beam) of the network entity, such that the UE may use the first receive beam, in combination with the transmission resource, for communications with the network entity.

However, the receive beam information associated with each receive beam of the UE (e.g., direction of each receive beam, width of each receive beam) may disclose proprietary information about the UE to the network entity. That is, based on the receive beam information associated with each receive beam at the UE, the network entity may determine proprietary information of the UE, such as a beam codebook of the UE, an antenna panel structure of the UE, antenna panel positions of the UE, pointing directions of the UE, or the like. Such information may be proprietary to the UE or manufacturers of components of the UE, where such proprietary information may be used as a competitive edge over other manufacturers of the UE. As such, it may be desirable by each manufacturer to protect (e.g., not disclose) such proprietary information. Further, in order for the network entity to accurately predict the beam pairs, the UE may transmit the receive beam information relatively frequently, thereby increasing the amount of overhead in the wireless communications system. For example, the UE may transmit receive beam information each time the UE moves or changes positions due to the changing of receive beam information associated with each receive beam. As such, if the UE is in a mobility state, the UE may transmit the receive beam information for each receive beam relatively frequently.

The techniques, methods, and devices described herein may enable a UE to transmit receive beam information associated with a subset of receive beams. For example, according to one or more aspects, the UE may transmit a report (e.g., a matrix, a two dimensional report, a multi-dimensional report, or the like) that includes receive beam information associated with the UE. In one example, a first dimension of the report (e.g., the columns of the matrix) may be associated with respective transmission resources (e.g., transmission beam) of the network entity, while a second dimension of the report (e.g., the rows of the matrix) may be associated with respective pointing directions of receive beams at the UE. In one example, the UE may populate the report with a fixed quantity of entries (e.g., such that the UE does not disclose proprietary information and incur additional overhead) that correspond to the receive beams (e.g., preferred receive beams) at the UE. For example, the UE may populate one or more entries of the report (e.g., such as column one, row two) with a non-zero value (e.g., such as a ‘1’) to indicate one or more preferred beam pairs. As such, the UE may transmit at least the non-zero values of the report, including the positions of the non-zero value entries (e.g., entries having a value of ‘1’), to the network entity, where such non-zero values may indicate a preferred beam pair, beam width, beam gains, or the like associated with respective receive beam pointing directions of the UE. In some examples, the UE may send only non-zero values, a complete report including zero and non-zero values, or a partial report including one or more non-zero value or one or more zero values. The network entity may use this beam pair information for beam pair prediction. For example, the network entity may use the respective beam pointing directions, beam widths, beam gains, or the like indicated in the report to predict measurements and beam pairs between transmission resources of the network entity and receive beams of the UE. In response to performing the beam pair prediction, the network entity may output an indication of which beam pair the UE is to use. For example, the network entity may transmit an index associated with the report, where the index identifies a respective receive beam pointing direction and transmission resource pair for the UE to use in order to receive a downlink message.

As described herein, receive beam information may refer to, or otherwise include, a receive beam of the UE, a beam pointing direction, a beam width, a beam gain, or a combination thereof. Further, the report may be an example of a two dimensional matrix, a multi-dimensional matrix (e.g., more than two dimensions), or the like. The first dimension of the report may be referred to as the columns, where each column may be associated with a transmission resource of the network entity. A transmission resource may refer to a transmission beam, a set of time and frequency resources associated with transmissions from a network entity, virtual resources, or both. Virtual resources may be one or more time and frequency resources that are indicated to the UE without information being transmitted via such time and frequency resources. That is, a network entity may output an indication of virtual resources (e.g., time and frequency locations) to the UE, without transmitting information over such time and frequency resources. As such, the UE may perform channel measurements on the virtual resources (e.g., time and frequency resources) without receiving a reference signal, data, or the like via the virtual resources. For example, the one or more transmission resources of the first dimension of the report may be based on virtual resources of the network entity.

The second dimension of the report may refer to the rows, where each row may be associated with a receive beam pointing direction at the UE. A receive beam pointing direction may refer to a direction in which a receive beam of the UE is pointing or is directed. Such directions may be in reference with the global coordinate system (GCS). The respective entries of the report may include receive beam information associated with a respective receive beam of the UE. A receive beam of the UE may be a beam generated by one or more antennas of the UE, such that the UE may receive one or more downlink or sidelink messages. For example, an entry associated with a first row and first column (e.g., a first receive beam pointing direction associated with a first transmission resource of the network entity) may indicate the beam width, beam gain, beam direction, or a preference associated with a first receive beam. The one or more positions of the report may refer to locations, or entries, in the report. As an illustrative example, a position in the report may refer to an entry in the first column and second row of the report.

The techniques described herein may enable the UE to provide the network entity with receive beam information for one or more receive beams of the UE without the disclosure of proprietary information and while reducing overhead. For example, due to receive beam information associated with a subset of receive beams at the UE being reported, the network entity may obtain enough information to accurately perform beam pair prediction without having access to or being informed of proprietary information about the UE. That is, the UE may report receive beam information associated with a subset of receive beams at the UE, such that the UE does not disclose receive beam information associated with each receive beam at the UE, thereby reducing the likelihood that proprietary information of the UE is disclosed. Further, the UE, the network entity, or both may configure a periodicity for communicating the report, configure a quantity of fixed entries in the report, or the like. As such, the overhead associated with transmitting the receive beam information may be reduced relative to reporting receive beam information for each receive beam at the UE.

Aspects of the disclosure are initially described in the context of wireless communications systems in accordance with one or more aspects of the present disclosure. Aspects of the disclosure are further described in the context of report diagrams and process flows in accordance with one or more aspects of the present disclosure. Aspects of the disclosure are further illustrated by and described with reference to apparatus diagrams, system diagrams, and flowcharts that relate to beam pair information reporting in accordance with one or more aspects of the present disclosure.

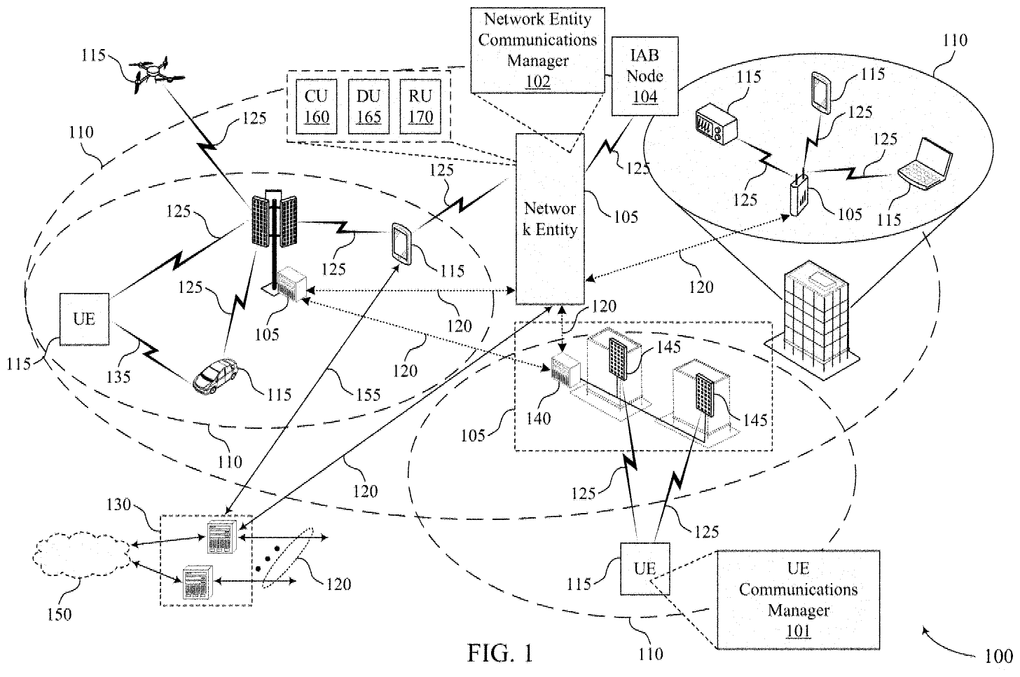

FIG. 1 illustrates an example of a wireless communications system 100 that supports beam pair information reporting in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs). The network entity 105 may include a network entity communications manager 102 to facilitate communications between a UE 115 and the network entity 105.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1. The UE 115 may include a UE communications manager 101 to facilitate communications between the UE 115 and a network entity 105, the UE 115 and one or more additional UEs 115 via sidelink, or a combination thereof.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB, a giga-NodeB (either of which may be referred to as a gNB), a 5G NB, a next-generation eNB (ng-eNB), a Home NodeB, a Home eNodeB, or other suitable terminology), or a network transmission entity 145. In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support beam pair information reporting as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may output a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may output a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Techniques described herein, in addition to or as an alternative to be carried out between UEs 115 and network entities 105, may be implemented via additional or alternative wireless devices, including IAB nodes 104, distributed units (DUs) 165, centralized units (CUs) 160, radio units (RUs) 170, and the like. For example, in some implementations, aspects described herein may be implemented in the context of a disaggregated radio access network (RAN) architecture (e.g., open RAN architecture). In a disaggregated architecture, the RAN may be split into three areas of functionality corresponding to the CU 160, the DU 165, and the RU 170. The split of functionality between the CU 160, DU 165, and RU 175 is flexible and as such gives rise to numerous permutations of different functionalities depending upon which functions (e.g., MAC functions, baseband functions, radio frequency functions, and any combinations thereof) are performed at the CU 160, DU 165, and RU 175. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more network entities 105 may include CUs 160, DUs 165, and RUs 170 and may be referred to as donor network entities 105 or IAB donors. One or more DUs 165 (e.g., and/or RUs 170) associated with a donor network entity 105 may be partially controlled by CUs 160 associated with the donor network entity 105. The one or more donor network entities 105 (e.g., IAB donors) may be in communication with one or more additional network entities 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of network entities 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host layer 3 (L3) (e.g., RRC, service data adaption protocol (SDAP), PDCP, etc.) functionality and signaling. The at least one DU 165 and/or RU 170 may host lower layer, such as layer 1 (L1) and layer 2 (L2) (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a network entity 105 may additionally or alternatively be performed by components of the disaggregated RAN architecture (e.g., IAB nodes, DUs, CUs, etc.).

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

As described herein, a node, which may be referred to as a node, a network node, a network entity 105, or a wireless node, may be a base station (e.g., any base station described herein), a UE 115 (e.g., any UE 115 described herein), a network controller, an apparatus, a device, a computing system, one or more components, and/or another suitable processing entity configured to perform any of the techniques described herein. For example, a network node may be a UE 115. As another example, a network node may be a network entity 105. As another example, a first network node may be configured to communicate with a second network node or a third network node. In one aspect of this example, the first network node may be a UE 115, the second network node may be a network entity 105, and the third network node may be a UE 115. In another aspect of this example, the first network node may be a UE 115, the second network node may be a network entity 105, and the third network node may be a network entity 105. In yet other aspects of this example, the first, second, and third network nodes may be different relative to these examples. Similarly, reference to a UE 115, network entity 105, apparatus, device, computing system, or the like may include disclosure of the UE 115, network entity 105, apparatus, device, computing system, or the like being a network node. For example, disclosure that a UE 115 is configured to receive information from a network entity 105 also discloses that a first network node is configured to receive information from a second network node. Consistent with this disclosure, once a specific example is broadened in accordance with this disclosure (e.g., a UE 115 is configured to receive information from a network entity 105 also discloses that a first network node is configured to receive information from a second network node), the broader example of the narrower example may be interpreted in the reverse, but in a broad open-ended way. In the example above where a UE 115 being configured to receive information from a network entity 105 also discloses that a first network node being configured to receive information from a second network node, the first network node may refer to a first UE 115, a first network entity 105, a first apparatus, a first device, a first computing system, a first one or more components, a first processing entity, or the like configured to receive the information; and the second network node may refer to a second UE 115, a second network entity 105, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The UE 115 and network entity 105 may communicate data via various beams. For example, the UE 115 may operate in an inactive or idle mode (e.g., RRC inactive or idle mode). The network entity 105 may output one or more tracking reference signals (TRSs) to the UE 115, while the UE 115 is operating in such modes. The UE 115 may use such TRSs to perform measurements and track one or more beams of the network entity 105. When the UE 115 has data to be transmitted, the UE 115 may perform an initial access procedure, in order to gain access to the network entity 105. For example, the UE 115 may perform a contention based random access (CBRA) procedure, where the UE 115 may select a random access preamble to use in order to gain access to the network. Further, the UE 115 may receive one or more synchronization signal blocks (SSBs), perform a beam sweeping procedure, and determine a beam to use for communications with the network entity.

In response to performing the CBRA procedure, the UE 115 may gain access to the network and perform beam management in order to maintain a connected state (e.g., RRC_CONNECTED state). For example, the UE 115 may perform a sunny day beam management procedure for both uplink and downlink beam management. In downlink beam management (e.g., P1/P2/P3 downlink beam management procedure), the UE 115 may receive one or more reference signals (e.g., SSBs or CSI-RSs) in order to perform and report channel measurements to the network entity 105. In this way, the UE 115 and network entity 105 may perform beam management in the downlink.

For uplink beam management (e.g., U1/U2/U3 uplink beam management procedures) the UE 115 may transmit one or more sounding reference signals (SRSs), such that the network entity 105 may perform channel measurements on such SRSs. In this way, the UE 115 and network entity 105 may perform beam management in the uplink. Further, the UE 115 may report L1 reference signal received power (RSRP) (L1-RSRP), while the network entity 105 may output transmission configuration indicator (TCI) state configurations.

In some examples, the UE 115, while operating in the connected mode, may report L1 signal-to-noise ratios (L1-SINRs) of one or more reference signals. In some examples, one or more procedures may be used by the UE 115 or the network entity 105 in order to reduce latency and overhead. For example, component carrier group beam update, relatively quicker uplink beam updates, unified TCI states, L1 and L2 centric mobility, dynamic TCI updates, uplink multi-panel selection, maximum power extrapolation reduction, a beam management latency reduction, or the like may be implemented to reduce latency in beam management. In some cases, the UE 115 and network entity may perform beam management for multi-transmission and reception points (mTRPs) in the wireless system.

While operating in the connected mode, the UE 115 or network entity 105 may experience beam failure. For example, based on measurements of the SSBs or CSI-RSs in the downlink or SRSs in the uplink, the UE 115 may perform a beam failure recovery procedure in order to reconnect to the network. For example, the UE 115 may implement beam failure detection and beam failure recovery procedures (e.g., for primary and secondary cells of the network entity) in order to reduce latency associated with beam failure. For example, the UE may detect beam failure based on measurements of beam failure detection reference signals and downlink control channel block error rate monitoring. Based on detecting beam failure, the UE 115 may use a contention free random access (CFRA) beam recovery procedure, transmit a link recovery request, or perform a MAC-control element (MAC-CE) beam failure recovery procedure. In some examples, the UE 115 may fail to perform beam failure recovery, which may lead to a radio link failure.

In some examples of the wireless communications system 100, a network entity 105, a UE 115, or both may use artificial intelligence, machine learning, or both for air interface correspondence, in order to target one or more use cases, increase performance, reduce complexity, and provide enhancements to NR systems. An initial set of use cases may include beam management, such as beam prediction in time, spatial domain for overhead and latency reduction, beam selection accuracy improvement, or a combination thereof. Artificial intelligence and machine learning may be used in order to finalize representative sub uses cases for each use case for characterization and baseline performance evaluations. Such approaches (e.g., artificial intelligence and machine learning) for the selected sub-use cases may be diverse enough to support various requirements on the network entity 105 to UE 115 (e.g., gNB to UE) collaboration levels. Further, the artificial intelligence and machine learning models and descriptions may identify common and specific characteristics for framework investigations, such as characterize lifecycle management of the artificial intelligence or machine learning model. That is, by using artificial intelligence or machine learning in such use cases, model training, model deployment, model inference, model monitoring, model updating, or a combination thereof may be investigated and implemented in such communications systems.

For example, multiple artificial intelligence and machine learning based beam management techniques may be supported in various scenarios. In a first beam management case (e.g., Beam Management Case1), machine learning and artificial intelligence may be used at the network or UE side in order to perform spatial-domain downlink beam prediction for a first set of beams (e.g., set A of beams or a prediction resource set) based on measurement results of a second set of beams (e.g., set B beams or channel measurement resources). In a second beam management case (e.g., Beam management case 2), artificial intelligence or machine learning may be used for temporal downlink beam prediction for the first set of beams based on the historic measurement results of the second set of beams. For either case (e.g., the first or second beam management case), the first and second set of beams may be in the same frequency range (e.g., such as FR1, FR2, or the like).

Further, artificial intelligence or machine learning may be used in a sub-use case of the first beam management case, where, in one example, the second set of beams is a subset of the first set of beams. In such cases, the UE 115 or network entity 105 may identify the quantity of beams in both the first and second set of beams may be known and identify the second set of beams out of the first set of beams (e.g., via a fixed pattern, random pattern, or the like). In another sub-use case of the first beam management case, artificial intelligence or machine learning may be used in cases where the first and second set of beams are different (e.g., the first set of beams includes narrow beams, and the second set of beams includes wide beams). In such sub-use cases, the UE 115 or network entity 105 may identify the quantity of beams in the first and second set of beams and a quasi-co-location (QCL) relation between the first and second set of beams. In such cases, the first set of beams may be for downlink beam prediction and the second set of beams may be for beam measurement. Further, in either beam management case, the codebook constructions of the first and second set of beams may be identified.

In some cases, for the first beam management case, the UE 115 may operate the artificial intelligence or machine learning model (e.g., a UE-side model). In such cases, the UE 115 may transmit L1 signaling to report information of AI/ML model inference to the network entity 105. For example, the UE 115 may report one or more beams that are based on the output of artificial intelligence or machine learning model inference, a predicted L1-RSRP corresponding to each of the one or more beams, among other information. Likewise, for the beam management case 2, the UE 115 may operate the artificial intelligence or machine learning model. In such cases, the UE may transmit L1 signaling to report the information associated with the artificial intelligence and machine learning model inference to the network entity 105. Such information may include one or more beams of N future time instances, where each beam and time instance are based on the output of model inference. The UE 115 may also report, via the L1 signaling, the value of N, a predicted L1-RSRP corresponding to each of the one or more beams, the timestamp corresponding to each of the one or more reported beams (e.g., such information may be explicitly indicated or implicitly determined), among other information.

For either beam management case where the UE 115 operates the artificial intelligence or machine learning mode, the UE 115, the network entity 105, or both may perform model monitoring with potential down-selection. In one example, the UE 115 may perform the model monitoring in order to monitor the performance metrics, perform determinations associated with model selection, activation, deactivation, switching, fallback operations, or the like. In some other cases, the network entity 105 may perform the model monitoring in order to monitor performance metrics, perform determinations of model selection, activation, deactivation, switching, fallback operations, or the like. Additionally, or alternatively, both the network entity 105 and the UE 115 may monitor the model (e.g., hybrid model monitoring), where the UE 115 may monitor the performance metrics, while the network entity 105 may perform determinations of model selection, activation, deactivation, switching, fallback operations, or the like.

Alternatively, for either beam management case, the network entity 105 (e.g., or some network functionalities) may operate the artificial intelligence or machine learning model, where the network entity 105 may perform model monitoring. For example, the network entity 105 may monitor the performance metrics perform determinations of model selection, activation, deactivation, switching, fallback operations, or the like. Further, in cases when the network entity 105 operates the model and performs model monitoring, the network entity 105 may control beam measurement and reporting for model monitoring. For example, if the network entity 105 is operating in either beam management case in addition to operating the model, the UE 115 may report the measurement results of more than four beams in one reporting instance, where such information may be used by the network entity 105 (e.g., via the model) to perform beam predictions.

For the sub-use cases in both the first and second beam management cases (e.g., spatial or temporal predictions for the first set of beams based on measurements of a second set of beams), the UE 115 and the network entity 105 may at least support model training and inference in cases where the second set of beams are a subset of the first set of beams or the first and second set of beams are different. For example, if the second set of beams are a subset of the first set of beams, then the network entity 105 may perform model training and inference. Alternatively, if the first and second set of beams are different, then the UE 115 may perform model training and inference. In some examples, the UE 115 and network entity 105 may support model transfers between the UE 115 and the network entity 105. For example, the network entity 105 may perform model training, while the UE 115 may perform model inference. In cases where the network entity 105 operates the model in either the first or second beam management case, the UE 115 may report, via L1 signaling, the measurement results of more than four beams in one reporting instance.

Regarding the data collection for the artificial intelligence or machine learning model training at the UE 115 side, the UE 115 or network entity 105 may determine whether and how to initiate data collection, determine configurations related to the first and second set of beams, determine and share information associated with mapping the first and second set of beams. In examples of data collection, the network entity 105 may output assistance information to UE 115. In cases where the network entity 105 operates and monitors the model in either beam management case, the UE may report beam measurements based on a set of beams indicated by the network entity 105. Such reporting may be through radio resource control messaging, L1 signaling, or the like. In such cases, the performance, complexity, and power consumption of the UE 115 may be considered.

In some examples of the wireless communications system 100, a network entity 105 may perform beam pair prediction between a transmission beam (e.g., a transmission resource) of the network entity 105 and a receive beam of a UE 115. In order to facilitate beam pair prediction at the network entity 105, the UE 115 may transmit, to the network entity 105, receive beam information including the direction associated with each receive beam at the UE 115, the width of each receive beam at the UE 115, or the like. The network entity 105 may use this receive beam information to predict the beam pairs and transmit, to the UE 115, an indication of which receive beam the UE 115 is to use. However, the receive beam information (e.g., direction of each receive beam, width of each receive beam) may disclose proprietary information about the UE 115 to the network entity 105. That is, based on the receive beam information associated with each receive beam at the UE 115, the network entity 105 may determine proprietary information of the UE 115, such as a beam codebook of the UE 115, an antenna panel structure of the UE 115, antenna panel positions of the UE 115, pointing directions of the UE 115, or the like, where the disclosure of such proprietary information may be disfavored. Further, in order for the network entity 105 to accurately predict the beam pairs, the UE 115 may transmit the receive beam information relatively frequently, thereby introducing an increased amount of overhead in the wireless communications system.

The techniques, methods, and devices described herein may enable the UE 115 to transmit receive beam information associated with a subset of receive beams. For example, the UE 115 may transmit receive beam information that includes a report (e.g., a matrix), where the first dimension of the report (e.g., the columns of the matrix) are each associated with a respective transmission resource (e.g., transmission beam) of the network entity 105, while the second dimension of the report (e.g., the rows of the matrix) are each associated with a respective pointing direction of receive beams at the UE 115. As such, the UE 115 may populate the report with a fixed quantity of entries that correspond to the preferred receive beams at the UE 115. For example, the UE 115 may populate an entry (e.g., such as column one, row two) with a ‘1’ to indicate that such a beam pair may be preferred. The network entity 105 may obtain, and use, this beam pair information for beam pair prediction. In response to performing the beam pair prediction, the network entity 105 may output an indication of which beam pair the UE 115 is to use. For example, the network entity 105 may output an index associated with the report, where the index identifies a respective receive beam pointing direction and transmission resource pair for the UE 115 to use in order to receive a downlink message.

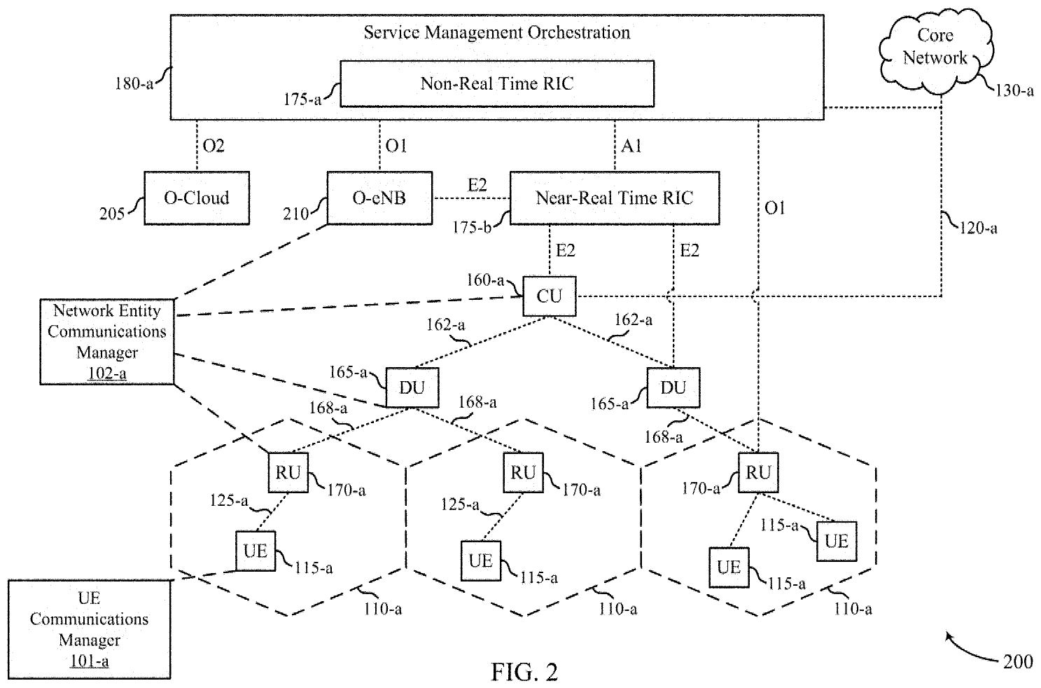

FIG. 2 illustrates an example of a network architecture 200 (e.g., a disaggregated base station architecture, a disaggregated RAN architecture) that supports beam pair information reporting in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include a network entity communications manager 102-a, which includes one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

In some examples, the UEs 115-a each may include respective UE communications managers 101-a, which may be an example of a UE communications manager as described herein. The UE communications manager 101-a may include, or be coupled with, one or more components (e.g., such as a processor, antennas, transmitters, receivers, or the like) that enable the UEs 115-a to communicate one or more packets of data with the RUs 170-a, DUs 165-a, CUs 160-a, and O-eNBs 210.

In some examples of the network architecture 200, a network entity 105 may perform beam pair prediction between a transmission beam (e.g., a transmission resource) of the network entity 105 and a receive beam of a UE 115. In order to facilitate beam pair prediction at the network entity 105, the UE 115 may transmit, to the network entity 105, receive beam information including the direction associated with each receive beam at the UE 115, the width of each receive beam at the UE 115, or the like. The network entity 105 may use this receive beam information to predict the beam pairs and transmit, to the UE 115, an indication of which receive beam the UE 115 is to use. However, the receive beam information (e.g., direction of each receive beam, width of each receive beam) may disclose proprietary information about the UE 115 to the network entity 105. That is, based on the receive beam information associated with each receive beam at the UE 115, the network entity 105 may determine proprietary information of the UE 115, such as a beam codebook of the UE 115, an antenna panel structure of the UE 115, antenna panel positions of the UE 115, pointing directions of the UE 115, or the like, where the disclosure of such proprietary information may be disfavored. Further, in order for the network entity 105 to accurately predict the beam pairs, the UE 115 may transmit the receive beam information relatively frequently, thereby introducing an increased amount of overhead in the wireless communications system.

The techniques, methods, and devices described herein may enable the UE 115 to transmit receive beam information associated with a subset of receive beams, such that receive beam information associated with each receive beam of the UE is not reported, thereby protecting proprietary information and reducing signaling overhead. For example, the UE 115 may transmit receive beam information that includes a report (e.g., a matrix), where the first dimension of the report (e.g., the columns of the matrix) are each associated with a respective transmission resource (e.g., transmission beam) of the network entity 105, while the second dimension of the report (e.g., the rows of the matrix) are each associated with a respective pointing direction of receive beams at the UE 115. As such, the UE 115 may populate the report with one or more non-zero values (e.g., a fixed quantity of entries) that correspond to the preferred receive beams at the UE 115. For example, the UE 115 may populate an entry (e.g., such as column one, row two) with a non-zero value (e.g., such as a ‘1’) to indicate that such a beam pair may be preferred. The network entity 105 may receive, and use, this beam pair information for beam pair prediction. In response to performing the beam pair prediction, the network entity 105 may output an indication of which beam pair the UE 115 is to use. For example, the network entity 105 may output an index associated with the report, where the index identifies a respective entry in the report. That is, the index may identify a receive beam pointing direction and transmission resource pair for the UE 115 to use in order to receive a downlink message.

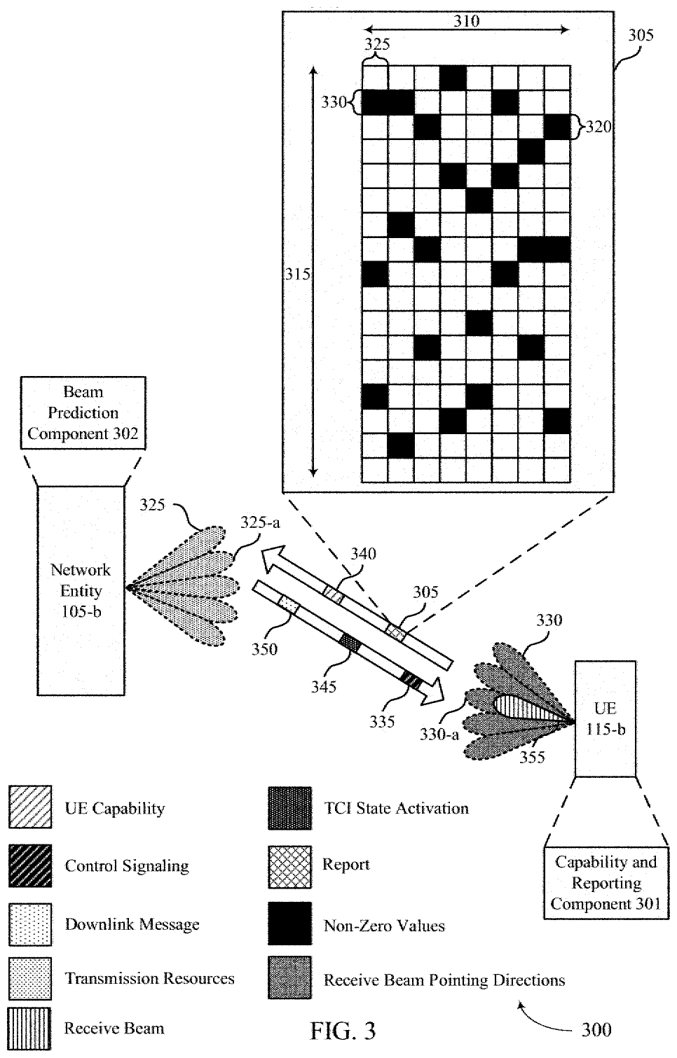

FIG. 3 illustrates an example of a wireless communications system 300 that supports beam pair information reporting in accordance with one or more aspects of the present disclosure. The wireless communications system 300 may implement or be implemented by aspects of the wireless communications system 100 and the network architecture 200 with reference to FIGS. 1 and 2. For example, the wireless communications system 300 may include a network entity 105-b and a UE 115-b, which may be examples of the network entities 105 and UEs 115 described herein. Further, the UE 115-b may include a capability and reporting component 301 and the network entity 105-b may include a beam prediction component 302.

In some cases of the wireless communications system 300, the network entity 105-b may predict beam pair qualities (e.g., predictions for pairs of transmission resources 325 of the network entity 105-b and reception beams of the UE 115-b) using an artificial intelligence or machine learning model. That is, the network entity 105-b may perform beam pair predictions using the beam prediction component 302, that includes the artificial intelligence or machine learning model. For example, the network entity 105-b may obtain L1-RSRPs associated with spatially down-sampled measurements of beam pairs from the UE 115-b. The network entity 105-b may use the L1-RSRPs in order to predict the L1-RSRP of other beam pairs via the artificial intelligence or machine learning model. By having the network entity 105-b operate the model and perform such beam prediction, the UE 115-b may experience reduced power consumption.

In order to facilitate beam predictions at the network entity 105-b, the UE 115-b may transmit receive beam information for each receive beam at the UE 115-b. In such cases, however, the transmission of receive beam information may disclose proprietary information associated with the UE 115-b. That is, in order to facilitate network side beam pair prediction, the UE 115-b may transmit information including receive beam direction, receive beam width, or the like for each receive beam at the UE 115-b. Based on the receive beam information, the network entity 105-b may determine proprietary information, such as a beam codebook of the UE 115-b, an antenna panel structure of the UE 115-b, antenna panel positions of the UE 115-b, pointing directions of the UE 115-b, or the like, where the disclosure of such proprietary information may be disfavored.

Further, the transmission of the receive beam information of the UE 115-b may incur a relatively large reporting overhead in the wireless communications system 300, where such overhead may be further increased while the UE 115-b is rotating or moving. For example, due to the rotation or movement of the UE 115-b, the UE 115-b may transmit (e.g., update) the receive beam information relatively frequently (e.g., relative to operating in a fixed position), which may consume a relatively large portion of uplink overhead. As such, one or more candidates receive beams at the UE 115-b may be dynamically varied based on the rotation and movement of the UE 115-b, such that the receive beam information reported by the UE 115-b may be insufficient and unapplicable to the network entity 105-b. As an illustrative example, the UE 115-b may contain at least 120 candidate receive beams. As such, if the UE 115-b transmits receive beam information associated with each of the 120 candidate receive beams and retransmits such information based on rotation or movement of the UE 115-b, the UE 115-b and the network entity 105-b may experience increased overhead, increased latency, and a reduction in communication quality.

In accordance with the techniques described herein, the UE 115-b may transmit, using the capability and reporting component 301, a report 305 (e.g., a beam pair matrix report, a multi-dimensional report) in order to reduce the disclosure of proprietary information of the UE 115-b (e.g., reduce the disclosure of receive beam implementation of the UE 115-b) and to further reduce uplink overhead associated with indicating receive beam information of the UE 115-b. For example, the capability and reporting component 301 may include one or more components (e.g., such as a processor, antennas, transmitters, receivers, or the like) that enable the UE 115-b to transmit the report 305 indicating the capability of the UE 115-b, receive beam information of the UE 115-b, or both.

The report 305 (e.g., which may be referred to as a sparse matrix, a two dimensional matrix, or the like) may include receive beam information and includes multiple dimensions including a first dimension 310 and a second dimension 315, where the first dimension 310 (e.g., the columns of the matrix) is associated with one or more transmission resources 325 of the network entity 105-b (e.g., a transmission beam of the network entity 105-b) and the second dimension 315 (e.g., the rows of the matrix) is associated with one or more receive beam pointing directions 330 of the UE 115-b. The report 305 may include one or more non-zero values 320, where such non-zero values 320 may indicate a preferred beam pair between a first receive beam pointing direction 330-a and a first transmission resource 325-a.

The report 305 may include a quantity of transmission resources 325 and a quantity of receive beam pointing directions 330, where such dimensions of the report 305 (e.g., the quantity of columns and quantity of rows) and the definition of each entry (e.g., in terms of the associated transmission resources and corresponding receive beam pointing directions) may be based on predefinition by a standards body (e.g., such as the 3GPP standards) or a technical specification according to which the wireless communications system 300 operates, signaling from the network entity 105-b, reporting by the UE 115-b, or a combination thereof.

In some examples, the network entity 105-b may output, via control signaling 335, a quantity of transmission resources 325 (e.g., a quantity of entries, a quantity of columns) in the first dimension 310 of the report 305. That is, the network entity 105-b may output an explicit indication of the quantity of transmission resources 325 associated with the first dimension 310. Additionally, or alternatively, the quantity of transmission resources 325 may be based on channel measurement resources or virtual resources indicated by the network entity 105-b and received by the UE 115-b (e.g., the quantity of channel measurement or virtual resources implicitly indicates the quantity of transmission resources). In such examples, the channel measurement resources or virtual resources may include associated pointing directions, beam width information, or the like. In cases where the UE 115-b is to transmit the report 305 via a CSI report in uplink control information (UCI), the network entity 105-b may configure the channel measurement resources or virtual resources via the associated CSI report setting, associated MAC-CE activating the semi-persistent CSI report, or via a CSI-AssociatedReportConfigInfo element for aperiodic CSI reports.

Further, the definition of the pointing directions associated with each receive beam pointing direction 330 (e.g., each entry) in the first dimension 310 may be predefined by a standards body (e.g., such as the 3GPP standards), configured by the network entity 105-b, based on capability reporting from the UE 115-b, or a combination thereof. In one example, the receive beam pointing directions 330 may be defined with respect to the GCS and azimuth angles represented in 360 degrees, where different entries (e.g., rows) in a column uniformly quantize a two dimensional space. In such examples, the degree values associated with entries of the first row in the report 305 may be pre-specified. As an illustrative example, if there are eight entries (e.g., rows) per column of the report 305 (e.g., eight receive beam pointing directions per transmission resource), then a first row of the report 305 may be associated with a receive beam pointing direction 330 of zero degrees, a second row may be associated with a receive beam pointing direction 330 of 45 degrees, a third row may be associated with a receive beam pointing direction 330 of 90 degrees, and so on (e.g., 0, 45, 90, 135, 180, 225, 270, 315). In this way, each respective transmission resource 325 (e.g., column) may be associated with receive beam pointing directions 330 that quantize the two dimensional space.

In another example, the receive beam pointing directions 330 may be defined with respect to the GCS, azimuth angles represented in 360-degrees, and elevation angles represented in 180 degrees where different entries (e.g., rows) in a column uniformly quantize a three dimensional space. In such examples, the degree value and resolution of the azimuth and elevation associated with the first component (e.g., row) may be pre-specified. As an illustrative example, if there are 16 receive beam pointing directions 330 (e.g., rows) per transmission resource 325 (e.g., per column), then a first row of the report 305 may be associated with a receive beam pointing direction 330 of zero degrees azimuth and −45 degrees elevation (e.g., 0/−45). Such ordering may increase per row by a resolution of 45 degrees azimuth and 90 degrees in elevation. (e.g., 0/−45, 0/+45, 45/−45, 45/+45, 90/−45, 90/+45, 135/−45, 135/+45, 180/−45, 180/+45, 225/−45, 225/+45, 270/−45, 270/+45, 315/−45, 315/+45).

In such examples (e.g., receive beam pointing directions 330 quantize two dimensional space or three dimensional space), the definition of the receive beam pointing directions 330 may be standardized (e.g., such as in the 3GPP standards). Additionally, or alternatively, the network entity 105-b may output control signaling 335 indicating the definition of the receive beam pointing directions 330 or the UE 115-b may transmit, using the capability and reporting component 301, a UE capability message 340 indicating the definition. In some examples, the definition of the receive beam pointing directions 330 (e.g., how they are quantized) may be referred to as a third dimension of the report 305.

Further, a total quantity of receive beam pointing directions 330 (e.g., quantity of entries) in the second dimension 315 may be based on reporting from the UE 115-b, configured by the network entity 105-b, or defined by a standards body (e.g., such as the 3GPP standards). For example, prior to, or concurrently with, transmitting the report 305, the UE 115-b may transmit the UE capability message 340 indicating a total quantity of possible receive beam pointing directions 330 (e.g., the maximum quantity of rows), a quantity of receive beam pointing directions 330 (e.g., the quantity of rows or entries) of the report 305, or a both. In some examples, the UE 115-b may transmit such information as part of the payload when reporting the report 305.

Alternatively, the standards body may define the total quantity of possible receive beam pointing directions 330 (e.g., the maximum quantity of rows), a quantity of receive beam pointing directions 330 (e.g., the quantity of rows or entries) of the report 305, or a both. In the case that either the UE 115-b or standards body define the total quantity of possible receive beam pointing directions 330 (e.g., the maximum quantity of rows), then network entity 105-b may indicate, via control signaling 335, a quantity of receive beam pointing directions 330 out of the total quantity of possible receive beam pointing directions 330.

The UE 115-b may populate the report 305 with one or more non-zero values 320, where such non-zero values 320 indicate a preferred beam pair. As an illustrative example, the UE 115-b may populate the report 305 with one or more non-zero values, where each non-zero value 320 is equal to one. As such, when a component (e.g., an entry) of the report 305 is equal to one (e.g., the entry has a non-zero value 320), then a receive beam associated with the indicated receive beam pointing direction 330 may be paired with a corresponding transmission resource 325 of the network entity 105-b. Otherwise, if the entry of the report is equal to zero, then such a receive beam pointing direction 330 may be unassociated with a receive beam at the UE 115-b, unassociated with a transmission resource 325 at the network entity 105-b, or both.

Moreover, in some examples, the UE 115-b may transmit one or more non-zero values 320 that further indicate beam width or beam gain information associated with a receive beam at the UE 115-b. For example, the UE 115-b may include beam width and beam gain information associated with one or more receive beams at the UE 115-b in the non-zero values 320 in accordance with a standard predefinition (e.g., as predefined in the 3GPP standards), based on an indication from the network entity 105-b, based on capability reporting by the UE 115-b, or a combination thereof.

In one example, the standards body may predefine one or more options associated with a quantity of bits to be used for the non-zero values 320. As such, the UE 115-b may convey information associated with beam width and beam gain for one or more receive beams of the UE 115-b in accordance with the one or more options associated with the predefined quantity of bits. For example, the standards may predefine an option that includes using zero bits in the non-zero values 320. In such examples, the UE 115-b may refrain from reporting beam width and beam gain information and report the preferred beam pointing directions via the non-zero values 320.

Additionally, the standards may predefine an option that includes using greater than zero bits in the non-zero values 320. In such examples, the UE 115-b may quantize beam width information, beam gain information, or both using the predefined quantity of bits. Such predefinitions may be further based on separate definitions for quantizing beam gain only, or beam width only, or both beam gain and width, respectively.

In such examples (e.g., using standard predefinition), the UE 115-b may transmit the UE capability message 340 indicating which option the UE 115-b supports. For example, the UE 115-b may transmit, via the capability message 340, that the UE 115-b supports the zero bit option. As such, the UE 115-b may refrain from reporting the beam width and beam gain via the non-zero values 320. In some examples, the network entity 105-b, via the control signaling 335, may indicate the quantity of bits per non-zero values 320 in the report 305. That is, based on the one or more options (e.g., zero bit non-zero values 320, or multi-bit non-zero values 320), the network entity 105-b may indicate which option the UE 115-b is to use for reporting the report 305.

In some examples, the network entity 105-b may indicate the quantity of bits used in the non-zero values 320 based on the artificial intelligence or machine learning model used by the network entity 105 for beam prediction. For example, depending on the implementation of the artificial intelligence or machine learning model, the network entity 105-b may determine whether quantizing the beam gain and beam width via multiple bits in the non-zero values 320 is required. As such, based on the determination, the network entity 105-b may output control signaling 335 to the UE 115-b indicating the quantity of bits to use for the non-zero values 320 of the report 305. In cases where the UE 115-b is to transmit the report 305 via a CSI report in UCI, the network entity 105-b may configure the quantity of bits via the associated CSI report setting, associated MAC-CE activating the semi-persistent CSI report, or via a CSI-AssociatedReportConfigInfo element for aperiodic CSI reports. In some examples, the quantization of the beam gain, beam widths, or the like in the one or more non-zero values 320 of the report 305 may be referred to as a fourth dimension of the report 305.

In some examples, the total quantity of non-zero values 320 may be fixed. For example, the total quantity of non-zero values 320 may be fixed per transmission resource 325 (e.g., per column). As such, the quantity of receive beams of the UE 115-b associated with a single transmission resource 325 of the network entity 105-b may be fixed, resulting in a fixed quantity of beam pairs (e.g., pairs between transmission resources of the network entity 105-b and receive beams of the UE 115-b). As an illustrative example, the total quantity of non-zero values 320 per transmission resource 325 (e.g., per column) may be fixed at a value of three. As such, the UE 115-b may populate the report with up to three non-zero values 320 per transmission resource 325.

Additionally, or alternatively, the total quantity of non-zero values 320 may be fixed per the report 305 (e.g., per the matrix). As such, the total quantity of beam pairs may be fixed, but the total quantity of receive beams associated with a single transmission resource 325 of the network entity 105-b may be variable. As an illustrative example, the total quantity of non-zero values 320 per report 305 may be fixed at a value of ten. As such, the UE 115-b may populate the report 305 with up to ten non-zero values 320, but such non-zero values 320 may be in any combination. For example, the UE 115-b may populate the first column associated with a first transmission resource 325 of the report 305 with ten non-zero values 320, and refrain from populating the other columns with non-zero values 320.

Further, the total quantity of non-zero values 320 (e.g., per report 305 or per transmission resource 325) may be in accordance with capability reporting of the UE 115-b, an indication from the network entity 105-b, or standard predefinition. For example, prior to, or concurrently with, transmitting the report 305, the UE 115-b may transmit a UE capability message 340 indicating the a total quantity of possible non-zero values 320 per the report 305 (e.g., a maximum quantity of non-zero values 320 per matrix), a total quantity of possible non-zero values 320 per transmission resource 325 (e.g., a maximum quantity of non-zero values 320 per column), a quantity of non-zero values 320 per report 305, a quantity of non-zero values per transmission resource 325, or a combination thereof. In some examples, the UE 115-b may transmit such information as part of the payload when reporting the report 305.

Additionally, or alternatively, the standards body may predefine a total quantity of possible non-zero values 320 per the report 305 (e.g., a maximum quantity of non-zero values 320 per matrix), a total quantity of possible non-zero values 320 per transmission resource 325 (e.g., a maximum quantity of non-zero values 320 per column), a quantity of non-zero values per report 305, a quantity of non-zero values 320 per transmission resource 325, or a combination thereof. As such, the network entity 105-b and UE 115-b may operate according to the predefined quantities.

In some examples, based on the UE capability message 340, the standard predefinition, or both, if a total quantity of possible non-zero values 320 (e.g., maximum per matrix or column) is reported or defined, the network entity 105-b may output, via control signaling 335, a quantity of non-zero values 320 (e.g., per matrix, per column, or both) to the UE 115-b, where the UE 115-b may populate the report 305 accordingly. In cases where the UE 115-b is to transmit the report 305 via a CSI report in UCI, the network entity 105-b may configure the quantity of non-zero values 320 (e.g., per matrix, per column, or both) via the associated CSI report setting, associated MAC-CE activating the semi-persistent CSI report, or via a CSI-AssociatedReportConfigInfo element for aperiodic CSI reports.

In response to generating the report 305 and populating the report 305 with non-zero values 320, the UE 115-b may transmit the report 305 via RRC signaling, MAC-CE signaling, or UCI. In some examples, the UE 115-b may report the report 305 dynamically based on which candidate receive beams are preferred at the UE 115-b. In such examples, the UE 115-b may transmit the report 305 using overhead reduction techniques due to the sparse nature of the report 305 (e.g., because a fixed quantity of non-zero values 320 may be reported).

As described herein, the UE 115-b may transmit report 305 via a CSI report in UCI. The CSI report may be an example of a periodic CSI report, semi-persistent CSI report, or aperiodic CSI report. In such examples, the UE 115-b may transmit, in addition to the report 305, the dimension information associated with the report 305, such as a total quantity of rows (e.g., total quantity of receive beam pointing directions), a quantity of non-zero values 320 per transmission resource 325 or per the report 305, or a combination thereof.

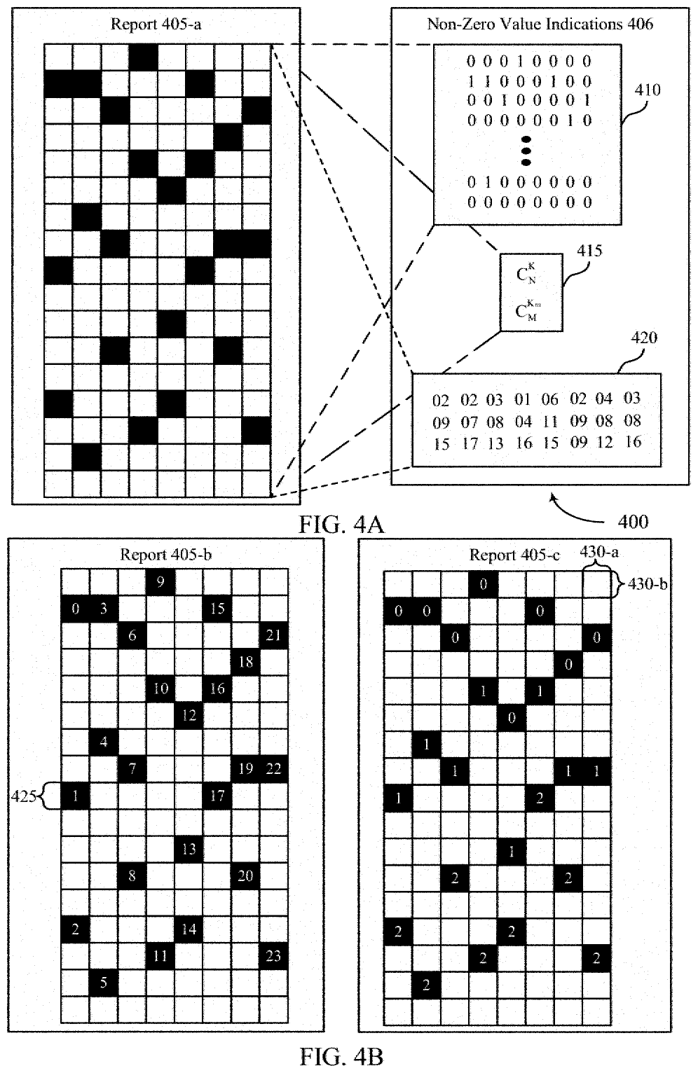

For example, the UE 115-b may transmit the dimension information of the report 305, via a first part of the CSI (e.g., CSI part 1), where the first part of the CSI has a fixed payload size. That is, the UE 115-b may transmit the quantity of receive beam pointing directions 330, the quantity of non-zero values 320 (e.g., per column or matrix) via the first part CSI. As such, the UE 115-b may transmit the report 305, including the position of each non-zero value 320, the values of the non-zero values 320, or both, in a second part CSI (e.g., CSI part 2). The positions of each non-zero value 320 may be indicated according to techniques further described herein with reference to FIG. 4A.

In such examples, the network entity 105-b may determine the payload size of the second part CSI based on the information in the first part CSI (e.g., based on the dimension information indicated in the first part CSI). As such, the second part CSI may have a variable sized payload. In some examples, the UE 115-b may transmit the report 305 via a single part CSI based on an indication from the network entity 105-b, standard predefinition, or both.

In some other examples, the UE 115-b may transmit the report via RRC signaling or MAC-CE signaling. In such examples, the network entity 105-b may output an RRC configuration, MAC-CE activation commands, or downlink control information (DCI) indicating one or more uplink resources, such that the UE 115-b may use such resources to transmit the report 305.

In response to receiving the report 305, the network entity 105-b may obtain a first receive beam pointing direction 330-a based on performing a beam prediction procedure using the beam prediction component 302. That is, the network entity 105-b may input the non-zero values 320 of the report 305 into the artificial intelligence or machine learning model of the beam prediction component 302, and output a preferred beam pair. The network entity 105-b may output, using the beam prediction component 302, a TCI state activation command 345 indicating the preferred beam pair (e.g., the first receive beam pointing direction 330-a associated with a first transmission resource 325-a) to the UE 115-b. The indication of the preferred beam pair may be further described herein with reference to FIG. 4B. Based on the preferred beam pair, the UE 115-b may determine a receive beam 355 associated with the first receive beam pointing direction 330-a (e.g., indicated via the beam pair prediction) and receive a downlink message 350 using the receive beam 355.

In this way, due to the receive beam pointing directions 330 being defined by the GCS and a subset of the overall receive beams of the UE 115-b being reported via the report 305, the network entity 105-b may be unable to determine the proprietary information of the UE 115-b (e.g., such as the receive beam codebook of the UE 115-b). Further, the UE 115-b may experience lower uplink reporting overhead due to the configuration (e.g., definition) of the report 305. That is, because the UE 115-b may report receive beam information for a subset of receive beams of the UE 115-b, the UE 115-b may dynamically update the report relatively frequently and without incurring additional overhead, resulting in relatively smaller reporting.

FIG. 4 A and FIG. 4B illustrate examples of a report diagram 400 and a report diagram, respectively, that support beam pair information reporting in accordance with one or more aspects of the present disclosure. The report diagram 400 and the report diagram may implement, or be implemented by, aspects of the wireless communications system 100, the network architecture 200, and the wireless communications system 300 as described herein. For example, the report diagram 400 and the report diagram may be implemented by a UE and a network entity. The report diagram 400 and the report diagram may include a report 405, which may be an example of a report 305 as described herein with reference to FIG. 3.

Regarding the report diagram 400 and in accordance with aspects of the present disclosure, the UE may generate a report 405-a, where a first dimension (e.g., the columns) of the report 405-a is associated with one or more transmission resources of the network entity and a second dimension (e.g., the rows) of the report 405-a is associated with one or more receive beam pointing directions of the UE. Further, the report 405-a may include one or more non-zero values. The non-zero values may indicate a preferred beam pair between one or more receive beam pointing directions of the UE and one or more transmission resources of a network entity. The UE may transmit the report 405-a to the network entity, such that the network entity may use the receive beam information (e.g., non-zero values) in the report 405-a to perform beam pair prediction.

In some examples, prior to, or concurrently with, transmitting the report 405-a, the UE may transmit an indication of the positions of each non-zero value with respect to the report 405-a, such that the network entity may identify the preferred beam pairs and process the receive beam information. Such positional information may be indicated via one or more non-zero value indication methods 406, such as a bitmap 410, a combinatorial index 415, and a row index 420.

In some examples, the UE may transmit the bitmap 410 indicating the positions of each non-zero value with respect to the report 405-a. In order to indicate such positional information, the UE may set each bit in the bitmap 410 to a corresponding component in the report 405-a. As an illustrative example, if the report 405-a has a first dimension with eight entries (e.g., the matrix has eight columns) and a second dimension of 17 entries (e.g., the matrix has 17 rows), the corresponding bitmap 410 may have 136 bits (e.g., 8*17=136), where each bit may represent an entry in the report 405-a. As such, the UE may populate the bits in the bitmap 410 with a ‘1’ to indicate a non-zero value for the associated receive beam pointing direction and the corresponding transmission resource, while a zero in the bitmap 410 is associated with a zero value component of the report 405-a.

In some other examples, the UE may transmit the combinatorial index 415 indicating the positions of each non-zero value with respect to the report. In one example, the combinatorial index 415 may be with respect to the entire report, where the combinatorial index 415 may be equal to:

$${C}_{N}^{K} .$$

As such, the combinatorial index may be used to feedback the positions of the non-zero values, where N is the total quantity of entries in the report 405-a and K is the total quantity of non-zero values in the report 405-a. As an illustrative example, if the report 405-a has a first dimension with eight entries (e.g., the matrix has eight columns) and a second dimension of 17 entries (e.g., the matrix has 17 rows), the value of N may be equal to 136. Further, the value of K may be equal to 24. As such, the network entity may use the combinatorial index, with the values of 136 and 24 to identify the positions of the non-zero values.

In another example, the combinatorial index 415 may be with respect to separate combinatorial indices associated with the first dimension of the report. That is, the combinatorial index may be with respect to separate combinatorial indices for different columns, where such a combinatorial index 415 may be equal to:

$${C}_{M}^{{K}_{m}} .$$

The combinatorial index 415 may be used to feedback the positions of the non-zero values for the m^{th} row, where M is the quantity of entries in the second dimension of the report 405 (e.g., the quantity of rows) and Kₘ may be the total quantity of non-zero values in the m^{th} row. As described herein, if the total quantity of non-zero values is fixed per transmission resource (e.g., per column), then Kₘ may be identical for different receive beam pointing directions (e.g., rows) of the report. Otherwise, the UE may first report the value of Kₘ via the first part CSI(e.g., in CSI Part-1), and then report

$${C}_{M}^{{K}_{m}}$$

via the second part CSI (e.g., in CSI Part-2).

In some examples, the UE may transmit indices of the second dimension for respective entries of the first dimension in order to report the locations of the non-zero values in the report 405-a. That is, the UE may transmit row indices for the respective columns of the report 405-a. For example, the UE may use log₂ M bits in order to report a row index for a first receive beam pointing direction, where M is equal to the total quantity of entries in the second dimension (e.g., total quantity of rows). As described herein, if the quantity non-zero values per column is free (e.g., not fixed), the UE may first report the quantity of non-zero values for each column via a first part CSI (e.g., in CSI Part-1) and report the respective row indices via a second part CSI (e.g., in CSI Part-2). As an illustrative example, if the quantity of non-zero values per transmission resource (e.g., per column) is fixed at three, the UE may report three row indices associated with each column. For example, as illustrated in the report 405-a, the non-zero values associated with the first transmission resource may be positioned at the second entry, the ninth entry and the fifteenth entry. As such, the UE may report 02, 09, and 15, as the indices for the first transmission resource. The UE may report such values for each transmission resource (e.g., for each column) in the report 405-a.

Further, the UE may report the values of the non-zero values in addition to the position of the non-zero values. In one example, if the non-zero values are unassociated with beam width and beam gain information, then the UE may refrain from reporting the values. That is, because the non-zero values are unassociated with beam width and beam gain information, the UE may report the positions of the preferred receive beam pointing directions (e.g., the non-zero values), without reporting additional bits in each non-zero value. Alternatively, if the non-zero values are quantized in accordance with the techniques described in FIG. 3 (e.g., based on a standards body definition, network configuration, or UE reporting), then the UE may report beam information via one or more bits in each non-zero value. That is, if the non-zero values carry beamforming width and beamforming gain information, the UE may report such information, where the quantity of bits per non-zero value may be based on a standards body definition, network configuration, or UE reporting as described herein with respect to FIG. 3

Regarding the report diagram of FIG. 4B and in accordance with aspects of the present disclosure, the network entity may use the information received via the report 405-a (e.g., the positions and values of the non-zero values) as inputs to a machine learning or artificial intelligence model in order to perform beam pair prediction and obtain a preferred receive beam pointing direction (e.g., a first receive beam pointing direction). In response to obtaining the preferred receive beam pointing direction, the network entity may transmit a TCI state activation command (e.g., such as the TCI state activation command 345) that includes an indication of the preferred receive beam pointing direction (e.g., the preferred beam pair). In order to provide the indication to the UE, the network entity may use beam pair indexing (e.g., a single dimensional index 425), as represented in the report 405-b, or receive beam indexing (e.g., multi-dimensional index 430), as represented in the report 405-c.

In the example of beam pair indexing, the network entity may transmit, via a TCI state activation MAC-CE or a receive beam refinement command, an indication of one or more beam pairs, where the indicated beam pair index is defined in accordance with the most recently transmitted report 405. Such indexing may be based on a standards definition or network configuration, where the non-zero values of the report 405-b are first ordered by transmission resources (e.g., the columns) and then ordered by receive beam pointing (e.g., the rows).

For example, if the network entity receives the report 405-b and the network entity is using beam pair indexing, the network entity may assign a respective index to each non-zero value of the report 405-b, where the assigning begins in the first column. As an illustrative example, the network entity may assign the index of the first non-zero value in the first column to be the zero, the index of the second non-zero value in the first column to be one, and the index of the third non-zero value in the first column to be two. Once the network entity has assigned an index to each non-zero value in the first column, the network entity may begin indexing the second column, starting with an index value of three. In this way, each non-zero value may be associated with a respective index. As such, in the TCI state activation command or receive beam refinement command, the network entity may include an indication of such indexing and provide an indication to one or more preferred receive beam pairs. For example, the network entity may determine, based on the machine learning or artificial intelligence model, that the beam pairs associated with indices 3, 8, 14, and 16 are preferred. As such, the network entity may transmit, via the TCI state activation command or receive beam refinement command, an indication that the beam pairs associated with indices 3, 8, 14, and 16 are preferred. Such an indication may be referred to as a single dimensional index 425.

In the example of receive beam indexing, the network entity may transmit, via a TCI state activation MAC-CE or a receive beam refinement command, an indication of one or more beam pairs, where the indicated beam pair index is defined in accordance with the most recently reported report 405. Such indices may be further based on the separate network commands that first indicate a transmission resource (e.g., that is based on a SSB or CSI-RS), and additionally indicate a receive beam pointing direction associated with the transmission resource. In such examples, the receive beam index may be based on the defined in accordance with the most recently reported report 405.

For example, if the network entity receives the report 405-c and is using receive beam indexing, the network entity may index each non-zero value with respective indices per transmission resource (e.g., per column). As an illustrative example, the network entity may receive the report 405-c and assign the index of the first non-zero value associated with the first column (e.g., first transmission resource) to be zero, the index of the second non-zero value associated with the first column to be one, and the index of the third non-zero value associated with the first column to be two. As such, the network entity may restart such indexing based on each column, where, for example, the network entity assigns the index of the first non-zero value in the second column to be zero. As such, each column (e.g., transmission resource) may contain respective indices for the non-zero values.

In such examples, the network entity may transmit, via the TCI state activation command or receive beam refinement command, a multi-dimensional index 430, where the first dimension 430-a of the multi-dimensional index 430 indicates a respective transmission resource (e.g., a respective column), while the second dimension 430-b of the multi-dimensional index 430 may indicate the respective receive beam pointing direction associated with the non-zero value. As an illustrative example, the network entity may indicate one or more multi-dimensional indices 430 with values of (1, 1), (3, 2), and (5, 2), where the first dimension 430-a corresponds to the transmission resource and the second dimension 430-b corresponds to the respective receive beam pointing direction.

In some examples, the network entity may include, in the TCI state activation command or receive beam refinement command, a CSI report setting identifier, a CSI report slot identifier, or both. For example, if the UE transmits the reports 405 via a CSI report in UCI, then the network entity may indicate, via the TCI state activation command or receive beam refinement command, the CSI report setting identifier, the slot or subframe identifier associated with the CSI report setting, or both in order to avoid ambiguity issues. For example, in order to indicate to the UE that the indexes in the TCI state activation command or receive beam refinement command are associated with the most recent report 405, the network entity may include identifiers associated with the CSI report that the UE used to transmit the most recent report 405. In this way, the UE may identify the preferred receive beams from the correct report 405 based on the received indexes.

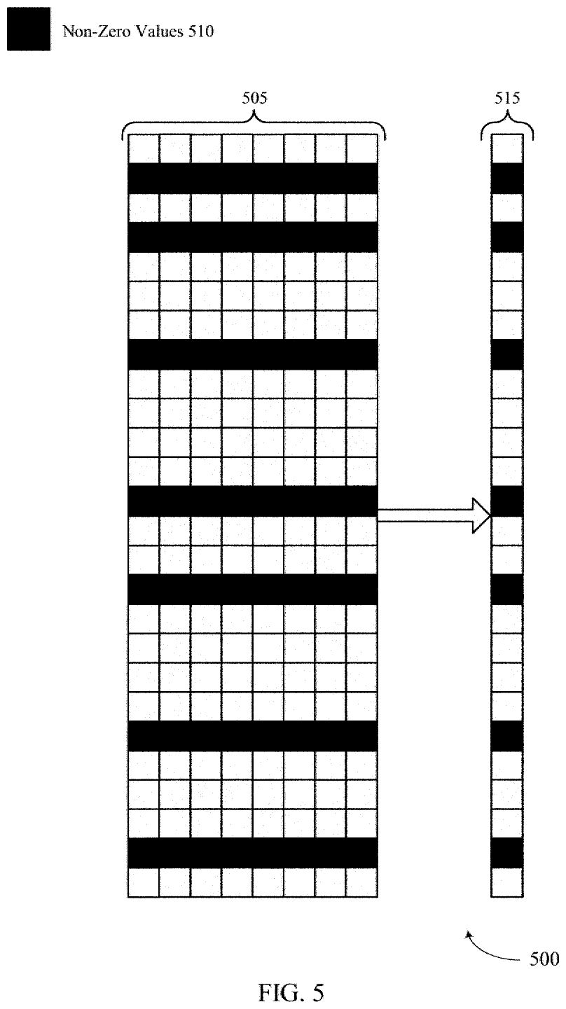

FIG. 5 illustrates an example of a report diagram 500 that supports beam pair information reporting in accordance with one or more aspects of the present disclosure. The report diagram 500 may be implement, or be implemented by, aspects of the wireless communications system 100, the network architecture 200, the wireless communications system 300, the report diagram 400, and the report diagram as described herein with reference to FIGS. 1 through 4B. For example, the report diagram 500 may be implemented by a UE and include a report 505, which may be an example of a report 305, a report 405-a, report 405-b, and report 405-c as described herein.

In accordance with aspects of the present disclosure, a UE may generate a report 505, where a first dimension (e.g., the columns) of the report 505 is associated with one or more transmission resources of a network entity and a second dimension (e.g., the rows) of the report 505 is associated with one or more receive beam pointing directions of the UE. Further, the report 505 may include one or more non-zero values 510. The non-zero values 510 may indicate a preferred beam pair between one or more receive beam pointing directions of the UE and one or more transmission resources of a network entity. The UE may transmit the report 505 to the network entity, such that the network entity may use the receive beam information (e.g., non-zero values 510) in the report 505 to perform beam pair prediction.

In some examples, the UE may generate the report 505, where each transmission resource of the network entity (e.g., each column) of the report may correspond to identical receive beam pointing directions of the UE. That is, each transmission resource of the network entity is associated with the same one or more receive beams of the UE. In such examples, instead of transmitting the report 505 indicating the same preferred receive beam pointing directions for each transmission resource, the UE may transmit a vector 515 in cases when each transmission resource of the network entity shares identical receive beams at the UE.

For example, a standards body (e.g., such as the 3GPP standards) may predefine, the network entity may configure, or the UE may report, that the receive beams at the UE with respect to various transmission resources of the network be the same, such that the report 505 becomes a vector 515. In one example, the network entity may transmit control signaling (e.g., such as control signaling 335) indicating that each receive beam pointing direction at the UE is to be the same for each transmission resource, such that the UE uses the vector 515 in order to indicate preferred beam pairs. In such examples, the control signaling may be an example of a CSI report setting, MAC-CE activating a semi-persistent CSI report, or a CSI-AssociatedReportConfigInfo for an aperiodic CSI report. In another example, the UE may transmit a UE capability message indicating that identical receive beams may be used for all transmission resources of the network entity. In such examples, the report 505 may use (e.g., fall back to) the vector 515.

In examples where the report 505 indicates the same receive beams for each transmission resource, the UE may transmit dimension identification associated with the vector 515. That is, the matrix dimension identification fallbacks to vector dimension identification, such as indicating a quantity of receive beam pointing directions associated with the vector 515, the quantity of non-zero values 510 associated with the vector 515, or the like. Similarly, reporting the locations of the non-zero values 510 in the matrix, fallbacks to reporting the locations of the non-zero values 510 the vector 515 or reporting the first column of the report 505. Such techniques may be implemented if the dimensions of the report 505 become relatively large, when the UE is unable to restore receive beams associated with one or more transmission resources, or both.

In this way, the UE may efficiently resize the report 505 to become a vector 515 in cases where the receive beam pointing directions are identical for each transmission resource indicated in the report, thereby resulting in reduced uplink overhead.

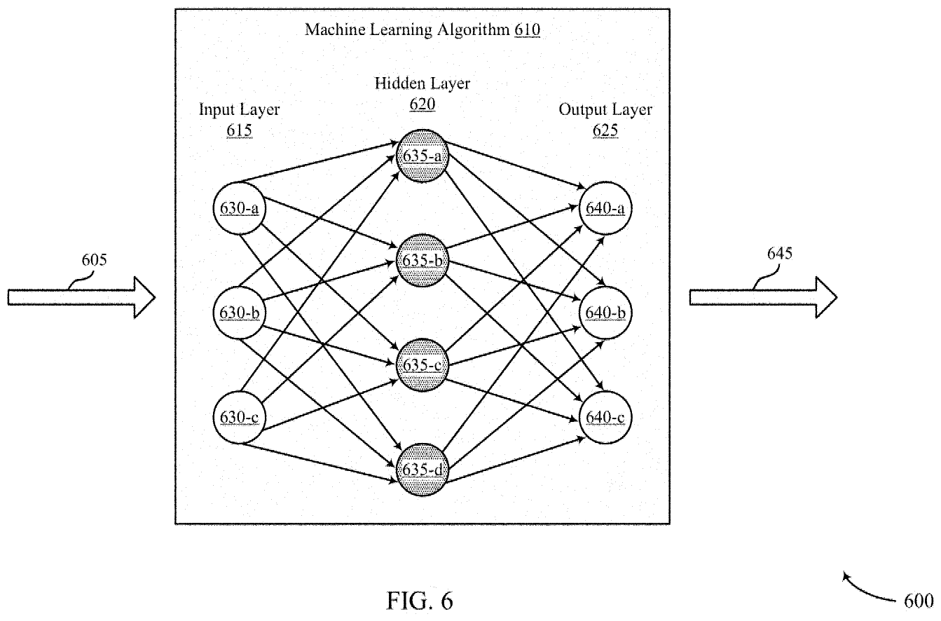

FIG. 6 illustrates an example of a machine learning diagram 600 that supports beam pair information reporting in accordance with one or more aspects of the present disclosure. The machine learning process may be implemented by aspects of the wireless communications system 100, the network architecture 200, the wireless communications system 300, the report diagram 400, the report diagram, and the report diagram 500 as described herein with reference to FIGS. 1 through 5. For example, the machine learning diagram 600 may be implemented at a network entity 105, or a UE 115, or both as described with reference to FIGS. 1 through 5.

The machine learning diagram 600 may include a machine learning algorithm 610. As illustrated, the machine learning algorithm 610 may be an example of a neural network, such as a feed forward (FF) or deep feed forward (DFF) neural network, a recurrent neural network (RNN), a long/short term memory (LSTM) neural network, or any other type of neural network. However, any other machine learning algorithms may be supported. For example, the machine learning algorithm 610 may implement a nearest neighbor algorithm, a linear regression algorithm, a Naïve Bayes algorithm, a random forest algorithm, or any other machine learning algorithm. Furthermore, the machine learning diagram 600 may involve supervised learning, unsupervised learning, semi-supervised learning, reinforcement learning, or any combination thereof.

The machine learning algorithm 610 may include an input layer 615, one or more hidden layers 620, and an output layer 625. In a fully connected neural network with one hidden layer 620, each hidden layer node 635 may receive a value from each input layer node 630 as input, where each input may be weighted. These neural network weights may be based on a cost function that is revised during training of the machine learning algorithm 610. Similarly, each output layer node 640 may receive a value from each hidden layer node 635 as input, where the inputs are weighted. If post-deployment training (e.g., online training) is supported, memory may be allocated to store errors and/or gradients for reverse matrix multiplication. These errors and/or gradients may support updating the machine learning algorithm 610 based on output feedback. Training the machine learning algorithm 610 may support computation of the weights (e.g., connecting the input layer nodes 630 to the hidden layer nodes 635 and the hidden layer nodes 635 to the output layer nodes 640) to map an input pattern to a desired output outcome. This training may result in a device-specific machine learning algorithm 610 based on the historic application data and data transfer for a specific network entity 105 or UE 115.

In some examples, input values 605 may be sent to the machine learning algorithm 610 for processing. Such input values 605 may include receive beam information of a UE indicated via a report (e.g., entries in the report). In some example, preprocessing may be performed according to a sequence of operations on the input values 605 such that the input values 605 may be in a format that is compatible with the machine learning algorithm 610. The input values 605 may be converted into a set of k input layer nodes 630 at the input layer 615. In some cases, different measurements may be input at different input layer nodes 630 of the input layer 615. Some input layer nodes 630 may be assigned default values (e.g., values of 0) if the number of input layer nodes 630 exceeds the number of inputs corresponding to the input values 605. As illustrated, the input layer 615 may include three input layer nodes 630-a, 630-b, and 630-c. However, it is to be understood that the input layer 615 may include any number of input layer nodes 630 (e.g., 20 input nodes).

The machine learning algorithm 610 may convert the input layer 615 to a hidden layer 620 based on a number of input-to-hidden weights between the k input layer nodes 630 and the n hidden layer nodes 635. The machine learning algorithm 610 may include any number of hidden layers 620 as intermediate steps between the input layer 615 and the output layer 625. Additionally, each hidden layer 620 may include any number of nodes. For example, as illustrated, the hidden layer 620 may include four hidden layer nodes 635-a, 635-b, 635-c, and 635-d. However, it is to be understood that the hidden layer 620 may include any number of hidden layer nodes 635 (e.g., 10 input nodes). In a fully connected neural network, each node in a layer may be based on each node in the previous layer. For example, the value of hidden layer node 635-a may be based on the values of input layer nodes 630-a, 630-b, and 630-c (e.g., with different weights applied to each node value).

The machine learning algorithm 610 may determine values for the output layer nodes 640 of the output layer 625 following one or more hidden layers 620. For example, the machine learning algorithm 610 may convert the hidden layer 620 to the output layer 625 based on a number of hidden-to-output weights between the n hidden layer nodes 635 and the m output layer nodes 640. In some cases, n=m. Each output layer node 640 may correspond to a different output value 645 of the machine learning algorithm 610. The output values 645 may indicate one or more beam pair predictions, such that the network entity (e.g., using the machine learning algorithm 610) may indicate such predictions to a UE. As illustrated, the machine learning algorithm 610 may include three output layer nodes 640-a, 640-b, and 640-c, supporting three different threshold values. However, it is to be understood that the output layer 625 may include any number of output layer nodes 640. In some examples, post-processing may be performed on the output values 645 according to a sequence of operations such that the output values 645 may be in a format that is compatible with reporting the output values 645.

In this way, the network entity may receive the report from the UE and input the non-zero values of the report into the machine learning algorithm 610 as input values 605. The network entity may use the machine learning algorithm to determine one or more output values 645, where such output values 645 indicate beam pair predictions for the UE. As such, the network entity may utilize the machine learning algorithm 610 to perform beam pair prediction efficiently and accurately.

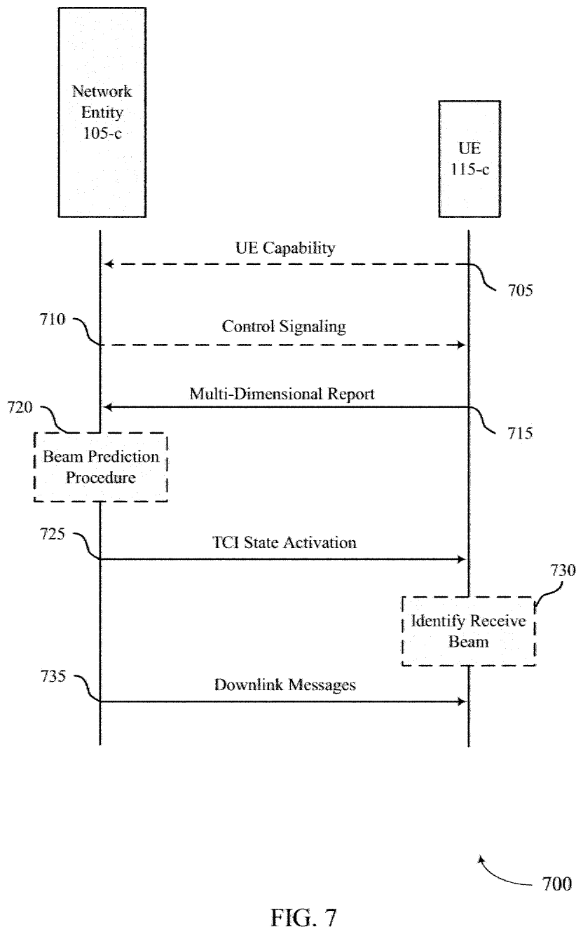

FIG. 7 illustrates an example of a process flow 700 that supports beam pair information reporting in accordance with one or more aspects of the present disclosure. The process flow 700 may implement, or be implemented by aspects of the wireless communications system 100, the network architecture 200, the wireless communications system 300, the report diagram 400, the report diagram, the report diagram 500, and the machine learning diagram 600 as described herein with reference to FIGS. 1 through 6. For example, the process flow 700 may be implemented by a network entity 105-c and a UE 115-c, which may be examples of corresponding devices described herein. In the following description of the process flow 700, the operations may be performed in a different order than the order shown. Specific operations also may be left out of the process flow 700, or other operations may be added to the process flow 700. Further, although some operations or signaling may be shown to occur at different times for discussion purposes, these operations may actually occur at the same time.

The process flow 700 may described techniques to enable a ULE 115-c to transmit a report (e.g., such as a report described herein with reference to FIGS. 3 through 5), where a first dimension (e.g., the columns of the report) may be associated with one or more transmission resources of the network entity 105-c and a second dimension (e.g., the rows) may be associated with one or more receive beam pointing directions of the UE 115-c.

For example, at 705, the UE 115-c may transmit a UE capability message (e.g., such as a UE capability message 340 with reference to FIG. 3), where the capability message may indicate a capability of the UE to report a report (e.g., report as described herein with reference to FIGS. 3 through 5). In some examples, the UE capability message may include a quantity of entries (e.g., such as a quantity of receive beam pointing directions as described herein with reference to FIG. 3) associated with a second dimension of the report, a quantity of non-zero values associated with the report, a quantity of non-zero values per transmission resource, or a combination thereof.

At 710, the network entity 105-c may output control signaling (e.g., such as control signaling 335), where such control signaling may indicate one or more dimensions associated with the report. For example, the network entity 105-c may indicate a total quantity of entries associated with the first dimension of the report (e.g., a total quantity of transmission resources or columns) and a total quantity of entries associated with the second dimension of the report (e.g., a total quantity of receive beam pointing directions or rows). The network entity 105-c may indicate one or more configuration associated with the report, such as a fixed quantity of non-zero values per transmission resource or per the report as described herein with reference to FIG. 3.

At 715, the UE 115-c may transmit the report indicating receive beam information for the UE. For example, the UE 115-c may transmit the report indicating one or more non-zero values associated with receive beam pointing directions in the report, where the one or more non-zero values indicate a preferred receive beam pointing direction, a beam width associated with each preferred receive beam pointing direction, a beamforming gain associated with each preferred receive beam pointing direction, or a combination thereof. The non-zero values may be examples of the non-zero values 320 described herein with reference to FIG. 3.

Further, in some examples, the UE 115-c may transmit positions of each of the one or more non-zero values in the report, where the positions are indicated via a bitmap, a combinatorial index, an index, or a combination thereof. Such position information may be examples of position indication as described herein with reference to FIG. 4A.

In some examples, the UE 115-c may transmit dimension information associated with the report via a first part CSI report (e.g., CSI part 1), while transmitting the positions and values of the non-zero values of the report in a second part CSI report (e.g., CSI part 2) as described herein with reference to FIG. 3.

In some examples, the ULE 115-c may transmit one or more non-zero values associated with one or more receive beam pointing directions at the UE 115-c for a single transmission resource (e.g., for a single column) based on the one or more non-zero values associated with the one or more receive beam pointing directions being equal for each transmission resource of the one or more transmission resources. That is, the UE 115-c may transmit a vector, such as the vector 515 as described herein with reference to FIG. 5, based on one or more receive beams being paired with the all the transmission resources of the network entity 105-c.

At 720, in response to receiving the report, the network entity 105-c may optionally perform a beam prediction procedure. For example, the network entity 105-c may obtain a first receive beam pointing direction based on the beam prediction procedure and on the report. In some examples, the network entity 105-c may use the one or more non-zero values and associated pairs between transmission resources and receive beam pointing directions as inputs into a machine learning or artificial intelligence model. The output of such model may be a preferred beam pair (e.g., the first receive beam pointing direction associated with a first transmission resource of the network entity 105-c.

At 725, the network entity 105-c may output a TCI state activation command, where the activation command includes an indication of the first receive beam pointing direction for use in a downlink message for the UE. In some examples, the TCI state activation command may include a two dimensional index (e.g., a row index and a column index), where a first dimension of the two dimensional index indicates the first transmission resource and a second dimension of the two dimensional index indicates the first receive beam pointing direction. In some other examples, the TCI state activation command may include a single dimensional index associated with the report, where the single dimensional index indicates a value of the first receive beam pointing direction. Further, in some examples, the TCI state activation command may include a CSI report setting identification, a slot identification, or both associated with the report, such that the UE 115-c may associated the indexes with the report. Such indexes and indications may be examples of indexes as described herein with reference to FIG. 4B.

At 730, in accordance with the index received in the TCI state activation command, the UE 115-c may identify a receive beam associated with the first receive beam pointing direction and the first transmission resource. At 735, the UE 115-c may receive the downlink message using the identified receive beam associated with the first receive beam pointing direction.

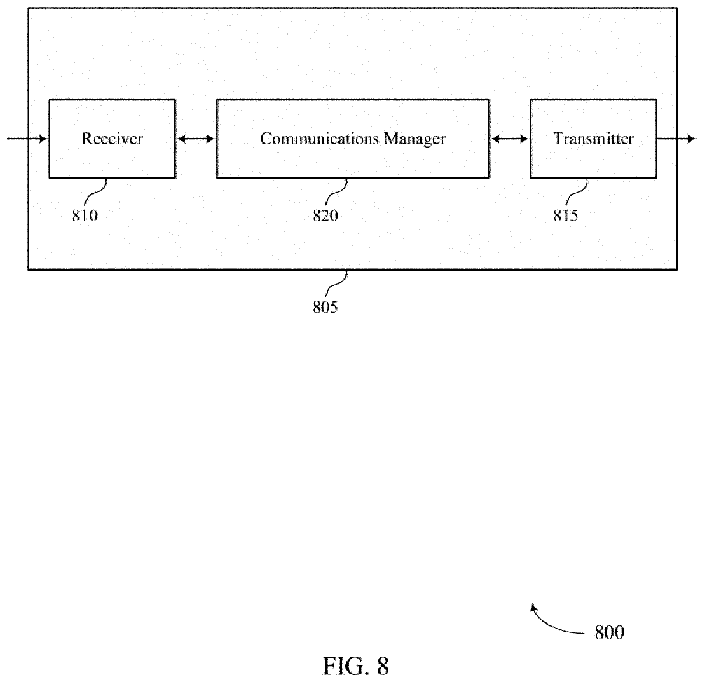

FIG. 8 illustrates a block diagram 800 of a device 805 that supports beam pair information reporting in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to beam pair information reporting). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to beam pair information reporting). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of beam pair information reporting as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. For example, the communications manager 820 may be configured as or otherwise support a means for transmitting a report that indicates receive beam information for the UE, a first dimension of the report associated with one or more transmission resources of a network entity, and a second dimension of the report associated with one or more receive beam pointing directions at the UE. The communications manager 820 may be configured as or otherwise support a means for receiving, based on the report, an indication of a first receive beam pointing direction of the one or more receive beam pointing directions for a downlink message for the UE, the first receive beam pointing direction associated with a first transmission resource of the one or more transmission resources. The communications manager 820 may be configured as or otherwise support a means for receiving the downlink message using a receive beam associated with the first receive beam pointing direction based on the indication of the first receive beam pointing direction.

The communications manager 820 may be an example of means for performing various aspects of managing beam pair prediction as described herein. The communications manager 820, or its sub-components, may be implemented in hardware (e.g., in communications management circuitry). The circuitry may comprise of processor, a DSP, an ASIC, an FPGA, or other programmable logic device, discrete gate or transistor logic, discrete hardware components, or any combination thereof designed to perform the functions described in the present disclosure.

In another implementation, communications manager 820, or its sub-components, may be implemented in code (e.g., as communications management software or firmware) executed by a processor, or any combination thereof. If implemented in code executed by a processor, the functions of the communications manager 820, or its sub-components may be executed by a general-purpose processor, a DSP, an ASIC, an FPGA, or other programmable logic device.

In some examples, the communications manager 820 may be configured to perform various operations (e.g., receiving, determining, transmitting, outputting, obtaining) using or otherwise in cooperation with the receiver 810, the transmitter 815, or both.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for beam pair prediction based on a report indicating beam information associated with a subset of receive beam pointing directions at a UE, which may reduce processing and be a more efficient utilization of communication resources.

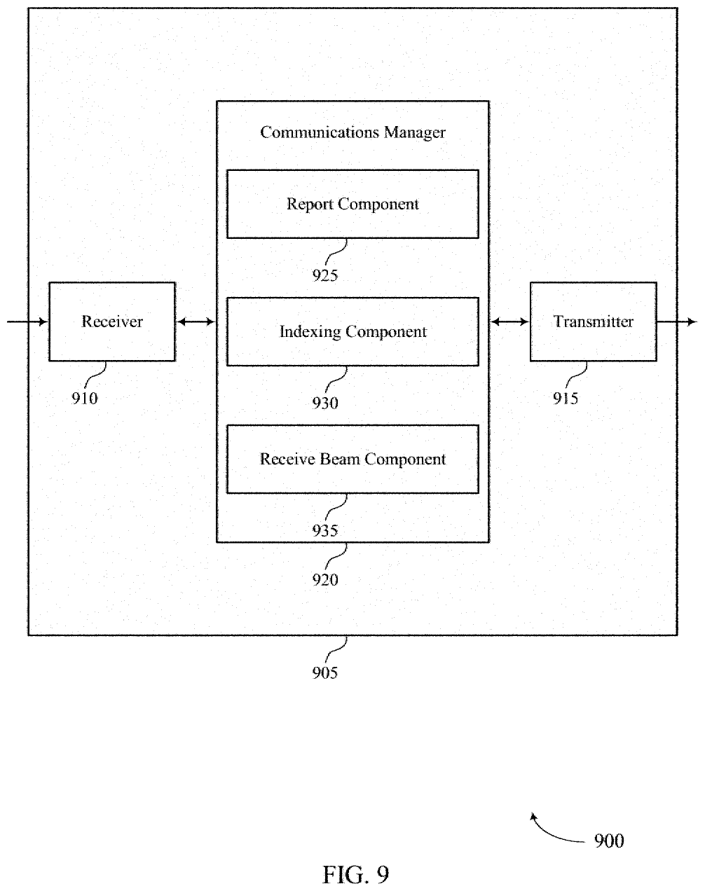

FIG. 9 illustrates a block diagram 900 of a device 905 that supports beam pair information reporting in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to beam pair information reporting). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to beam pair information reporting). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of beam pair information reporting as described herein. For example, the communications manager 920 may include a report component 925, an indexing component 930, a receive beam component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. The report component 925 may be configured as or otherwise support a means for transmitting a report that indicates receive beam information for the UE, a first dimension of the report associated with one or more transmission resources of a network entity, and a second dimension of the report associated with one or more receive beam pointing directions at the UE. The indexing component 930 may be configured as or otherwise support a means for receiving, based on the report, an indication of a first receive beam pointing direction of the one or more receive beam pointing directions for a downlink message for the UE, the first receive beam pointing direction associated with a first transmission resource of the one or more transmission resources. The receive beam component 935 may be configured as or otherwise support a means for receiving the downlink message using a receive beam associated with the first receive beam pointing direction based on the indication of the first receive beam pointing direction.

The communications manager 920 may be an example of means for performing various aspects of managing beam pair prediction as described herein. The communications manager 920, or its sub-components, may be implemented in hardware (e.g., in communications management circuitry). The circuitry may comprise of processor, DSP, an ASIC, a FPGA or other programmable logic device, discrete gate or transistor logic, discrete hardware components, or any combination thereof designed to perform the functions described in the present disclosure.

In another implementation, the communications manager 920, or its sub-components, may be implemented in code (e.g., as communications management software or firmware) executed by a processor, or any combination thereof. If implemented in code executed by a processor, the functions of the communications manager 920, or its sub-components may be executed by a general-purpose processor, DSP, an ASIC, a FPGA or other programmable logic device.

In some examples, the communications manager 920 may be configured to perform various operations (e.g., receiving, determining, transmitting, outputting, obtaining) using or otherwise in cooperation with the receiver 910, transmitter 915, or both.

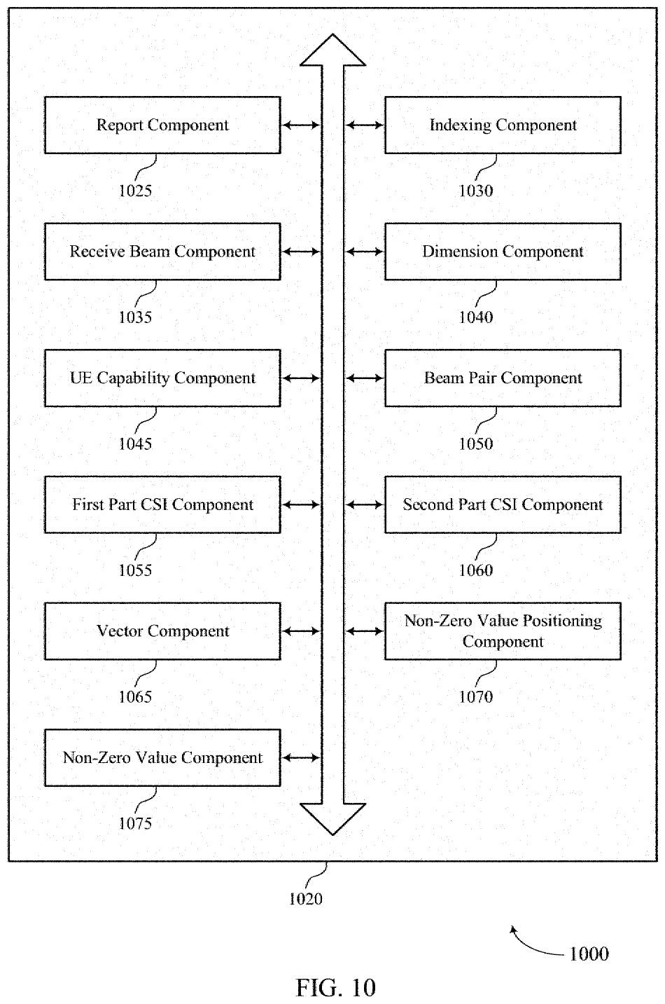

FIG. 10 illustrates a block diagram 1000 of a communications manager 1020 that supports beam pair information reporting in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of beam pair information reporting as described herein. For example, the communications manager 1020 may include a report component 1025, an indexing component 1030, a receive beam component 1035, a dimension component 1040, a UE capability component 1045, a beam pair component 1050, a first part CSI component 1055, a second part CSI component 1060, a vector component 1065, a non-zero value positioning component 1070, a non-zero value component 1075, or any combination thereof. Each of these components may communicate, directly or indirectly, with one another (e.g., via one or more buses).

The communications manager 1020 may support wireless communication at a UE in accordance with examples as disclosed herein. The report component 1025 may be configured as or otherwise support a means for transmitting a report that indicates receive beam information for the UE, a first dimension of the report associated with one or more transmission resources of a network entity, and a second dimension of the report associated with one or more receive beam pointing directions at the UE. The indexing component 1030 may be configured as or otherwise support a means for receiving, based on the report, an indication of a first receive beam pointing direction of the one or more receive beam pointing directions for a downlink message for the UE, the first receive beam pointing direction associated with a first transmission resource of the one or more transmission resources. The receive beam component 1035 may be configured as or otherwise support a means for receiving the downlink message using a receive beam associated with the first receive beam pointing direction based on the indication of the first receive beam pointing direction.

In some examples, the dimension component 1040 may be configured as or otherwise support a means for receiving an indication of a total quantity of entries associated with the first dimension of the report and a total quantity of entries associated with the second dimension of the report, where the report is in accordance with the indication.

In some examples, the total quantity of entries associated with the first dimension is based on one or more channel measurement resources, one or more virtual resources, or a combination thereof.

In some examples, the UE capability component 1045 may be configured as or otherwise support a means for transmitting an indication of a capability of the UE to report the report, the capability indicating a quantity of entries associated with the second dimension of the report, a quantity of non-zero values associated with the one or more receive beam pointing directions in the report, a quantity of non-zero values associated with the one or more receive beam pointing directions per transmission resource, or a combination thereof.

In some examples, the beam pair component 1050 may be configured as or otherwise support a means for transmitting one or more non-zero values associated with the one or more receive beam pointing directions in the report, where the one or more non-zero values indicate one or more preferred receive beam pointing directions associated with the one or more transmission resources of the network entity.

In some examples, the non-zero value positioning component 1070 may be configured as or otherwise support a means for transmitting an indication of positions of each of the one or more non-zero values in the report, where the positions are indicated via one of a bitmap, a combinatorial index, an index associated with each of the one or more receive beam pointing directions, or a combination thereof.

In some examples, the one or more non-zero values indicate a beam width associated with the one or more preferred receive beam pointing directions, a beamforming gain associated with the one or more preferred receive beam pointing directions, or both.

In some examples, a quantity of non-zero values associated with the one or more receive beam pointing directions is fixed per transmission resource.

In some examples, the non-zero value component 1075 may be configured as or otherwise support a means for receiving an indication of the quantity of non-zero values associated with the one or more receive beam pointing directions per transmission resource.

In some examples, a quantity of non-zero values associated with the one or more receive beam pointing directions is fixed for the report.

In some examples, the non-zero value component 1075 may be configured as or otherwise support a means for receiving an indication of the quantity of non-zero values associated with the one or more receive beam pointing directions in the report.

In some examples, the first part CSI component 1055 may be configured as or otherwise support a means for transmitting, via a first CSI message, a quantity of the one or more receive beam pointing directions at the UE, a quantity of non-zero values associated with the one or more receive beam pointing directions per transmission resource, a quantity of non-zero values associated with the one or more receive beam pointing directions in the report, or any combination thereof. In some examples, the second part CSI component 1060 may be configured as or otherwise support a means for transmitting, via a second CSI message and in accordance with the first CSI message, one or more non-zero values in the report, indexes associated with each of the one or more non-zero values, or both, where the one or more non-zero values indicate preferred receive beam pointing directions at the UE associated with transmission resources of the network entity.

In some examples, the indexing component 1030 may be configured as or otherwise support a means for receiving, via the indication, a multi-dimensional index associated with the report, where a first dimension of the multi-dimensional index indicates the first transmission resource of the one or more transmission resources of the network entity and a second dimension of the multi-dimensional index indicates the first receive beam pointing direction of the one or more or more receive beam pointing directions at the UE.

In some examples, the vector component 1065 may be configured as or otherwise support a means for transmitting one or more non-zero values associated with the one or more receive beam pointing directions at the UE for a single transmission resource of the network entity based on the one or more non-zero values associated with the one or more receive beam pointing directions being equal for each transmission resource of the one or more transmission resources.

In some examples, the indication of the first receive beam pointing direction includes a single dimensional index associated with the report that indicates the first receive beam pointing direction.

In some examples, the indication of the first receive beam pointing direction includes a CSI report setting identification, a slot identification associated with a transmission slot of the report, or both.

In some examples, the report includes a multi-dimensional report.

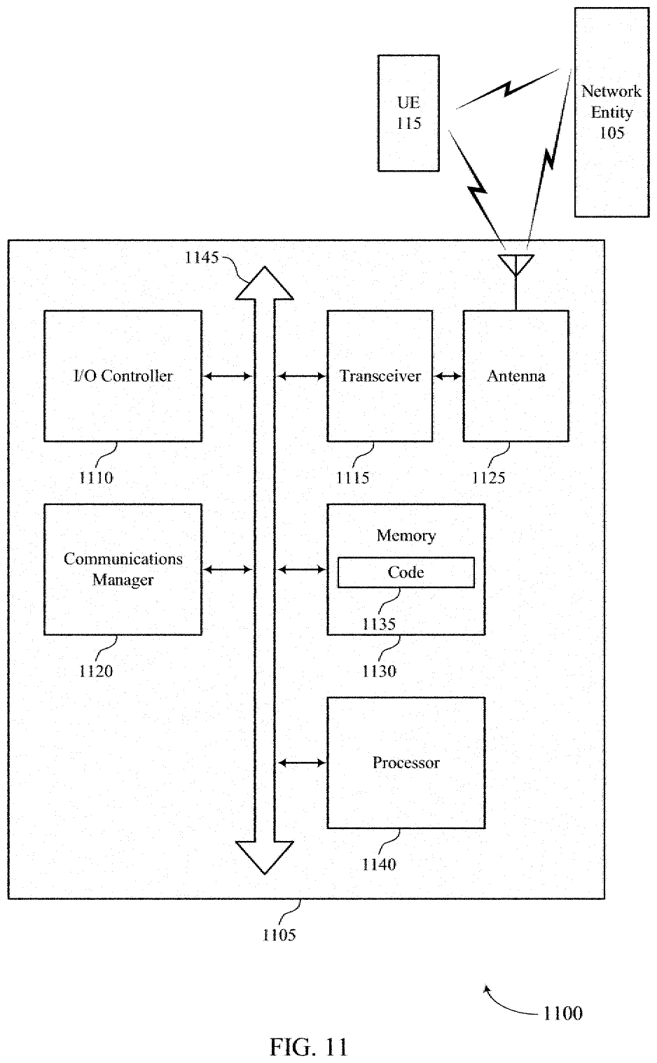

FIG. 11 illustrates a diagram of a system 1100 including a device 1105 that supports beam pair information reporting in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting beam pair information reporting). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a UE in accordance with examples as disclosed herein. For example, the communications manager 1120 may be configured as or otherwise support a means for transmitting a report that indicates receive beam information for the UE, a first dimension of the report associated with one or more transmission resources of a network entity, and a second dimension of the report associated with one or more receive beam pointing directions at the UE. The communications manager 1120 may be configured as or otherwise support a means for receiving, based on the report, an indication of a first receive beam pointing direction of the one or more receive beam pointing directions for a downlink message for the UE, the first receive beam pointing direction associated with a first transmission resource of the one or more transmission resources. The communications manager 1120 may be configured as or otherwise support a means for receiving the downlink message using a receive beam associated with the first receive beam pointing direction based on the indication of the first receive beam pointing direction.

By including or configuring the communications manager 1120 in accordance with examples as described herein, the device 1105 may support techniques for beam pair prediction based on a report indicating beam information associated with a subset of receive beam pointing directions at a UE, which may reduce power consumption and be a more efficient utilization of communication resources.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of beam pair information reporting as described herein, or the processor 1140 and the memory 1130 may be otherwise configured to perform or support such operations.

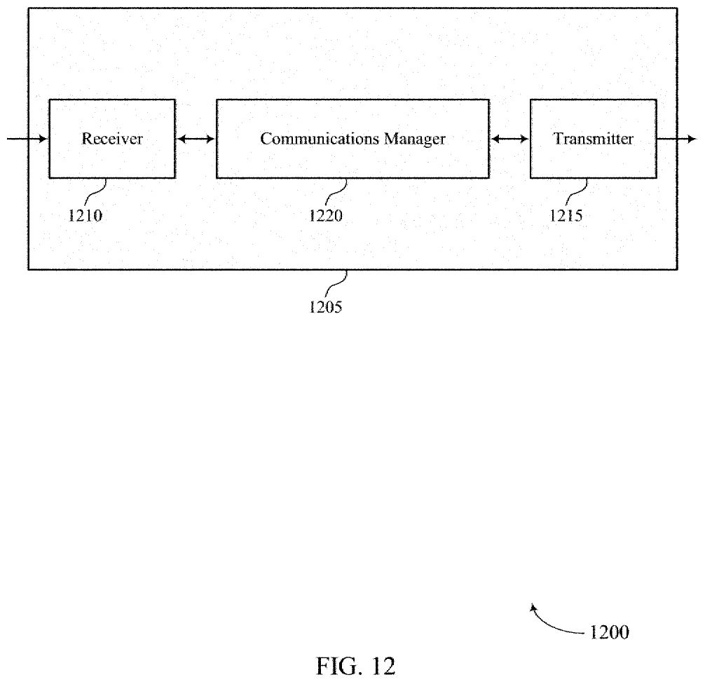

FIG. 12 illustrates a block diagram 1200 of a device 1205 that supports beam pair information reporting in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of beam pair information reporting as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

For example, the communications manager 1220 may be configured as or otherwise support a means for obtaining a report that indicates receive beam information for a UE, a first dimension of the report associated with one or more transmission resources of the network entity, and a second dimension of the report associated with one or more receive beam pointing directions for the UE. The communications manager 1220 may be configured as or otherwise support a means for outputting, basing at least in part on the report, an indication of a first receive beam pointing direction of the one or more receive beam pointing directions for use in a downlink message for the UE, the first receive beam pointing direction associated with a first transmission resource of the one or more transmission resources. The communications manager 1220 may be configured as or otherwise support a means for outputting the downlink message using the first transmission resource associated with the first receive beam pointing direction based on the indication of the first receive beam pointing direction.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for beam pair prediction based on a report indicating beam information associated with a subset of receive beam pointing directions at a UE, which may reduce processing and be a more efficient utilization of communication resources.

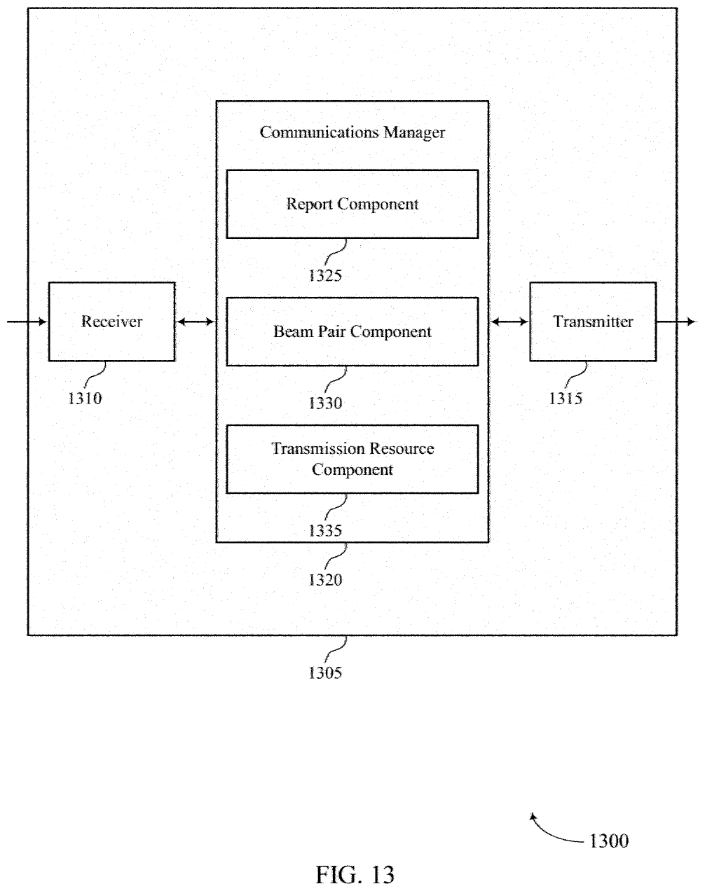

FIG. 13 illustrates a block diagram 1300 of a device 1305 that supports beam pair information reporting in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of beam pair information reporting as described herein. For example, the communications manager 1320 may include a report component 1325, a beam pair component 1330, a transmission resource component 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The report component 1325 may be configured as or otherwise support a means for obtaining a report that indicates receive beam information for a UE, a first dimension of the report associated with one or more transmission resources of the network entity, and a second dimension of the report associated with one or more receive beam pointing directions for the UE. The beam pair component 1330 may be configured as or otherwise support a means for outputting, based on the report, an indication of a first receive beam pointing direction of the one or more receive beam pointing directions for use in a downlink message for the UE, the first receive beam pointing direction associated with a first transmission resource of the one or more transmission resources. The transmission resource component 1335 may be configured as or otherwise support a means for outputting the downlink message using the first transmission resource associated with the first receive beam pointing direction based on the indication of the first receive beam pointing direction.

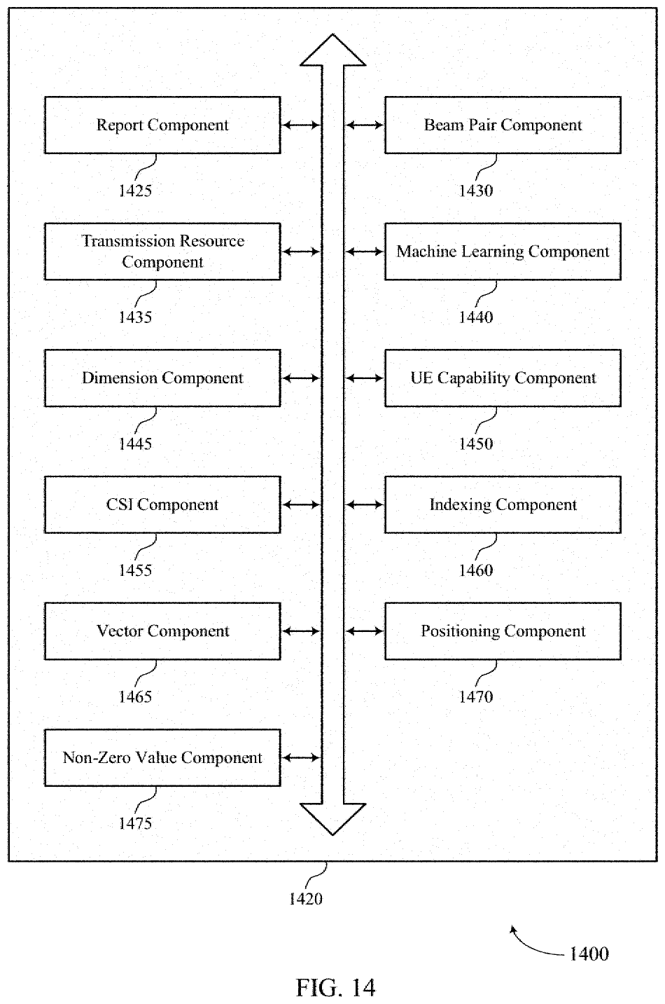

FIG. 14 illustrates a block diagram 1400 of a communications manager 1420 that supports beam pair information reporting in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of beam pair information reporting as described herein. For example, the communications manager 1420 may include a report component 1425, a beam pair component 1430, a transmission resource component 1435, a machine learning component 1440, a dimension component 1445, a UE capability component 1450, a CSI component 1455, an indexing component 1460, a vector component 1465, a positioning component 1470, a non-zero value component 1475, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The report component 1425 may be configured as or otherwise support a means for obtaining a report that indicates receive beam information for a UE, a first dimension of the report associated with one or more transmission resources of the network entity, and a second dimension of the report associated with one or more receive beam pointing directions for the UE. The beam pair component 1430 may be configured as or otherwise support a means for outputting, based on the report, an indication of a first receive beam pointing direction of the one or more receive beam pointing directions for use in a downlink message for the UE, the first receive beam pointing direction associated with a first transmission resource of the one or more transmission resources. The transmission resource component 1435 may be configured as or otherwise support a means for outputting the downlink message using the first transmission resource associated with the first receive beam pointing direction based on the indication of the first receive beam pointing direction.

In some examples, the machine learning component 1440 may be configured as or otherwise support a means for obtaining the first receive beam pointing direction based on a beam prediction procedure and on the report, where the outputted indication of the first receive beam pointing direction is in accordance with the obtained first receive beam pointing direction.

In some examples, the beam prediction procedure is based on a machine learning model.

In some examples, the dimension component 1445 may be configured as or otherwise support a means for outputting an indication of a total quantity of entries associated with the first dimension of the report and a total quantity of entries associated with the second dimension of the report, where the report is in accordance with the indication.

In some examples, the total quantity of entries associated with the first dimension is based on one or more channel measurement resources, one or more virtual resources, or a combination thereof.

In some examples, the UE capability component 1450 may be configured as or otherwise support a means for obtaining an indication of a capability of the UE to report the report, where the capability indicates a quantity of entries associated with the second dimension of the report, a quantity of non-zero values associated with the one or more receive beam pointing directions in the report, a quantity of non-zero values associated with the one or more receive beam pointing directions per transmission resource, or a combination thereof.

In some examples, the beam pair component 1430 may be configured as or otherwise support a means for obtaining one or more non-zero values associated with the one or more receive beam pointing directions in the report, where the one or more non-zero values indicate one or more preferred receive beam pointing directions associated with the one or more transmission resources of the network entity.

In some examples, the positioning component 1470 may be configured as or otherwise support a means for obtaining an indication of positions of each of the one or more non-zero values in the report, where the positions are indicated via one of a bitmap, a combinatorial index, an index associated with each of the one or more receive beam pointing directions, or a combination thereof.

In some examples, the one or more non-zero values indicate a beam width associated with the one or more preferred receive beam pointing directions, a beamforming gain associated with the one or more preferred receive beam pointing directions, or both.

In some examples, a quantity of non-zero values associated with the one or more receive beam pointing directions is fixed per transmission resource.

In some examples, the non-zero value component 1475 may be configured as or otherwise support a means for outputting an indication of the quantity of non-zero values associated with the one or more receive beam pointing directions per transmission resource.

In some examples, a quantity of non-zero values associated with the one or more receive beam pointing directions is fixed for the report.

In some examples, the non-zero value component 1475 may be configured as or otherwise support a means for outputting an indication of the quantity of non-zero values associated with the one or more receive beam pointing directions in the report.

In some examples, the CSI component 1455 may be configured as or otherwise support a means for obtaining, via a first CSI message, a quantity of the one or more receive beam pointing directions at the UE, a quantity of non-zero values associated with the one or more receive beam pointing directions per transmission resource, a quantity of non-zero values associated with the one or more receive beam pointing directions in the report, or any combination thereof. In some examples, the CSI component 1455 may be configured as or otherwise support a means for obtaining, via a second CSI message and in accordance with the first CSI message, one or more non-zero values in the report, indexes associated with each of the one or more non-zero values, or both, where the one or more non-zero values indicate one or more preferred receive beam pointing directions at the UE associated with transmission resources of the network entity.

In some examples, the indexing component 1460 may be configured as or otherwise support a means for outputting, via the indication, a multi-dimensional index associated with the report, where a first dimension of the multi-dimensional index indicates the first transmission resource of the one or more transmission resources of the network entity and a second dimension of the multi-dimensional index indicates the first receive beam pointing direction of the one or more or more receive beam pointing directions at the UE.

In some examples, the vector component 1465 may be configured as or otherwise support a means for obtaining one or more non-zero values associated with the one or more receive beam pointing directions at the UE for a single transmission resource of the network entity based on the one or more non-zero values associated with the one or more receive beam pointing directions being equal for each transmission resource of the one or more transmission resources.

In some examples, the indication of the first receive beam pointing direction includes a single dimensional index associated with the report that indicates the first receive beam pointing direction.

In some examples, the indication of the first receive beam pointing direction includes a CSI report setting identification, a slot identification associated with a transmission slot of the report, or both.

In some examples, the report includes a multi-dimensional report.

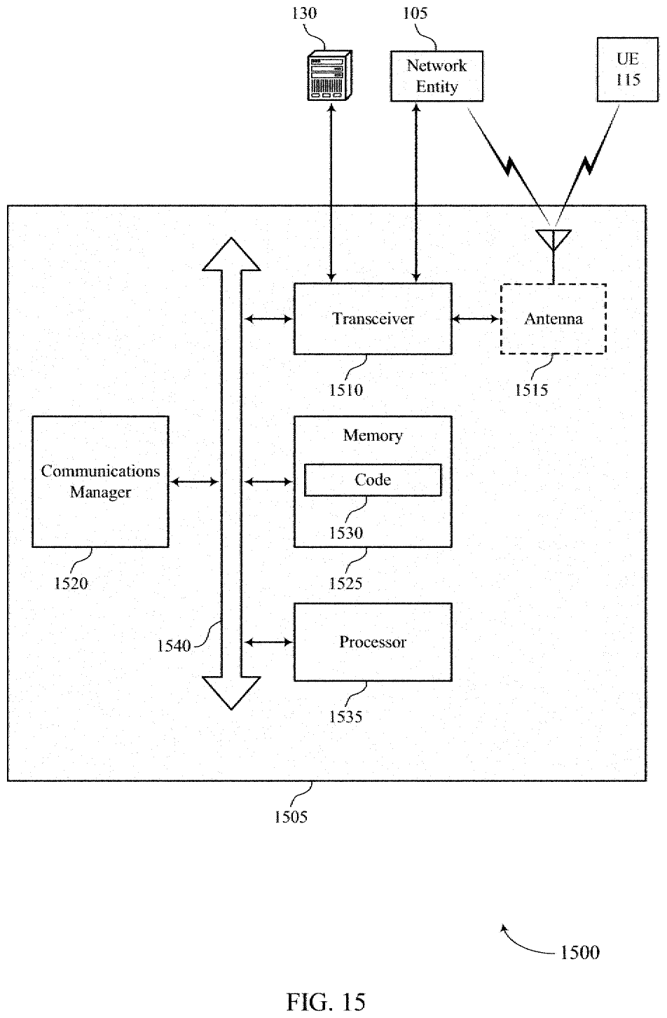

FIG. 15 illustrates a diagram of a system 1500 including a device 1505 that supports beam pair information reporting in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting beam pair information reporting). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

For example, the communications manager 1520 may be configured as or otherwise support a means for obtaining a report that indicates receive beam information for a UE, a first dimension of the report associated with one or more transmission resources of the network entity, and a second dimension of the report associated with one or more receive beam pointing directions for the UE. The communications manager 1520 may be configured as or otherwise support a means for outputting, basing at least in part on the report, an indication of a first receive beam pointing direction of the one or more receive beam pointing directions for use in a downlink message for the UE, the first receive beam pointing direction associated with a first transmission resource of the one or more transmission resources. The communications manager 1520 may be configured as or otherwise support a means for outputting the downlink message using the first transmission resource associated with the first receive beam pointing direction based on the indication of the first receive beam pointing direction.

By including or configuring the communications manager 1520 in accordance with examples as described herein, the device 1505 may support techniques for beam pair prediction based on a report indicating beam information associated with a subset of receive beam pointing directions at a UE, which may reduce power consumption and be a more efficient utilization of communication resources.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of beam pair information reporting as described herein, or the processor 1535 and the memory 1525 may be otherwise configured to perform or support such operations.

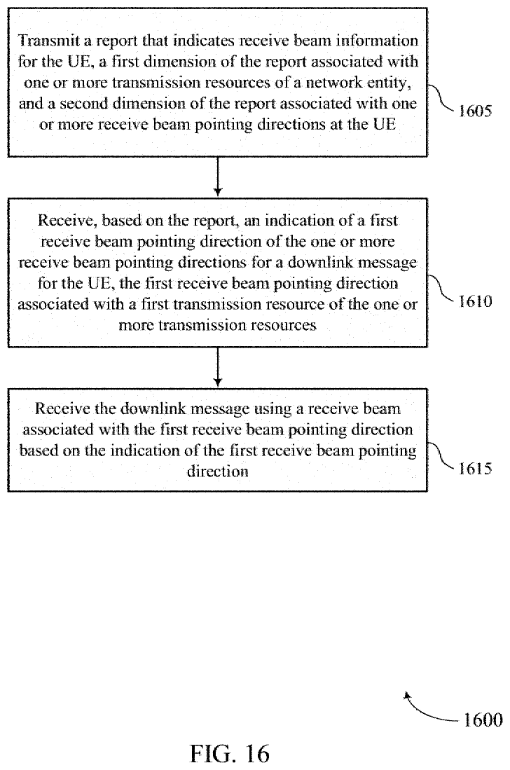

FIG. 16 illustrates a flowchart showing a method 1600 that supports beam pair information reporting in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include transmitting a report that indicates receive beam information for the UE, a first dimension of the report associated with one or more transmission resources of a network entity, and a second dimension of the report associated with one or more receive beam pointing directions at the UE. The operations of 1605 may be performed in accordance with examples as disclosed herein. In some examples, aspects of the operations of 1605 may be performed by a report component 1025 as described with reference to FIG. 10.

At 1610, the method may include receiving, based on the report, an indication of a first receive beam pointing direction of the one or more receive beam pointing directions for a downlink message for the UE, the first receive beam pointing direction associated with a first transmission resource of the one or more transmission resources. The operations of 1610 may be performed in accordance with examples as disclosed herein. In some examples, aspects of the operations of 1610 may be performed by an indexing component 1030 as described with reference to FIG. 10.

At 1615, the method may include receiving the downlink message using a receive beam associated with the first receive beam pointing direction based on the indication of the first receive beam pointing direction. The operations of 1615 may be performed in accordance with examples as disclosed herein. In some examples, aspects of the operations of 1615 may be performed by a receive beam component 1035 as described with reference to FIG. 10.

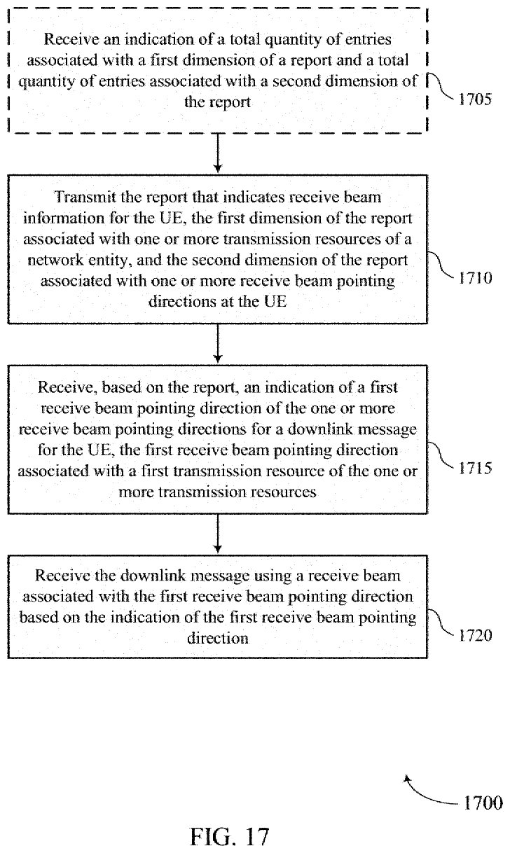

FIG. 17 illustrates a flowchart showing a method 1700 that supports beam pair information reporting in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving an indication of a total quantity of entries associated with a first dimension of a report and a total quantity of entries associated with a second dimension of the report. The operations of 1705 may be performed in accordance with examples as disclosed herein. In some examples, aspects of the operations of 1705 may be performed by a dimension component 1040 as described with reference to FIG. 10.

At 1710, the method may include transmitting the report that indicates receive beam information for the UE, the first dimension of the report associated with one or more transmission resources of a network entity, and the second dimension of the report associated with one or more receive beam pointing directions at the UE. The operations of 1710 may be performed in accordance with examples as disclosed herein. In some examples, aspects of the operations of 1710 may be performed by a report component 1025 as described with reference to FIG. 10.

At 1715, the method may include receiving, based on the report, an indication of a first receive beam pointing direction of the one or more receive beam pointing directions for a downlink message for the UE, the first receive beam pointing direction associated with a first transmission resource of the one or more transmission resources. The operations of 1715 may be performed in accordance with examples as disclosed herein. In some examples, aspects of the operations of 1715 may be performed by an indexing component 1030 as described with reference to FIG. 10.

At 1720, the method may include receiving the downlink message using a receive beam associated with the first receive beam pointing direction based on the indication of the first receive beam pointing direction. The operations of 1720 may be performed in accordance with examples as disclosed herein. In some examples, aspects of the operations of 1720 may be performed by a receive beam component 1035 as described with reference to FIG. 10.

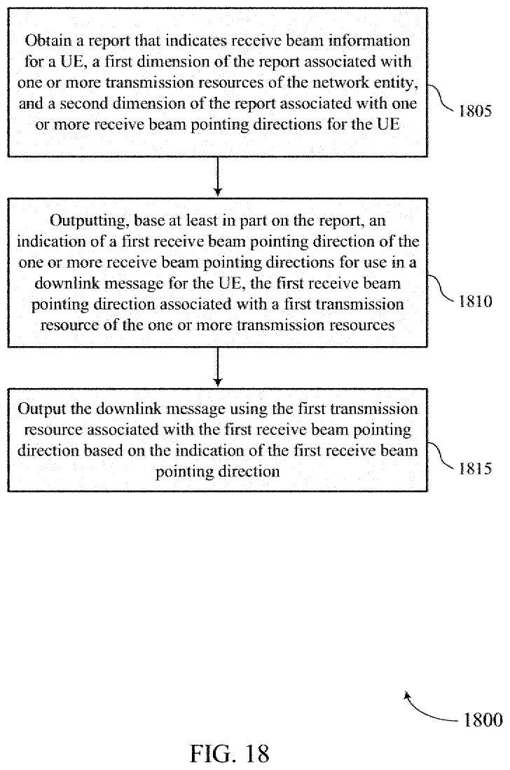

FIG. 18 illustrates a flowchart showing a method 1800 that supports beam pair information reporting in accordance with one or more aspects of the present disclosure. The operations of the method 1800 may be implemented by a network entity or its components as described herein. For example, the operations of the method 1800 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1805, the method may include obtaining a report that indicates receive beam information for a UE, a first dimension of the report associated with one or more transmission resources of the network entity, and a second dimension of the report associated with one or more receive beam pointing directions for the UE. The operations of 1805 may be performed in accordance with examples as disclosed herein. In some examples, aspects of the operations of 1805 may be performed by a report component 1425 as described with reference to FIG. 14.

At 1810, the method may include outputting, based on the report, an indication of a first receive beam pointing direction of the one or more receive beam pointing directions for use in a downlink message for the UE, the first receive beam pointing direction associated with a first transmission resource of the one or more transmission resources. The operations of 1810 may be performed in accordance with examples as disclosed herein. In some examples, aspects of the operations of 1810 may be performed by a beam pair component 1430 as described with reference to FIG. 14.

At 1815, the method may include outputting the downlink message using the first transmission resource associated with the first receive beam pointing direction based on the indication of the first receive beam pointing direction. The operations of 1815 may be performed in accordance with examples as disclosed herein. In some examples, aspects of the operations of 1815 may be performed by a transmission resource component 1435 as described with reference to FIG. 14.

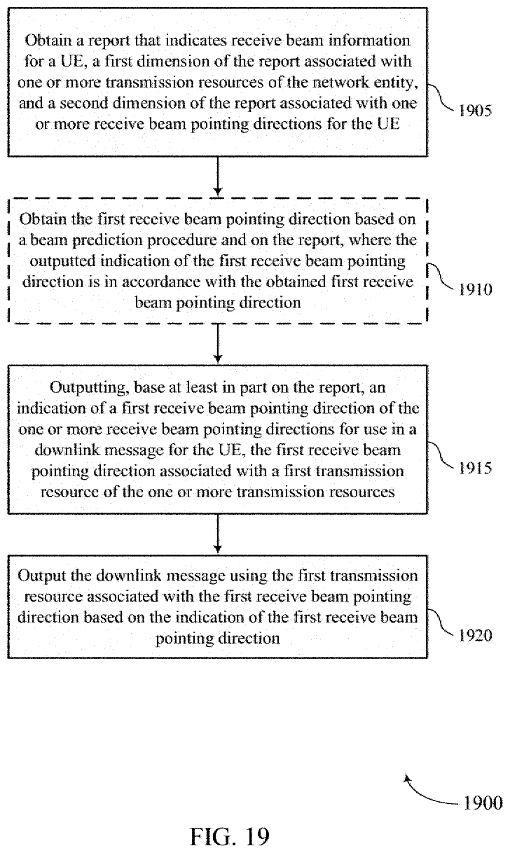

FIG. 19 illustrates a flowchart showing a method 1900 that supports beam pair information reporting in accordance with one or more aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1905, the method may include obtaining a report that indicates receive beam information for a UE, a first dimension of the report associated with one or more transmission resources of the network entity, and a second dimension of the report associated with one or more receive beam pointing directions for the UE. The operations of 1905 may be performed in accordance with examples as disclosed herein. In some examples, aspects of the operations of 1905 may be performed by a report component 1425 as described with reference to FIG. 14.

At 1910, the method may include obtaining the first receive beam pointing direction based on a beam prediction procedure and on the report, where the outputted indication of the first receive beam pointing direction is in accordance with the obtained first receive beam pointing direction. The operations of 1910 may be performed in accordance with examples as disclosed herein. In some examples, aspects of the operations of 1910 may be performed by a machine learning component 1440 as described with reference to FIG. 14.

At 1915, the method may include outputting, based on the report, an indication of a first receive beam pointing direction of the one or more receive beam pointing directions for use in a downlink message for the UE, the first receive beam pointing direction associated with a first transmission resource of the one or more transmission resources. The operations of 1915 may be performed in accordance with examples as disclosed herein. In some examples, aspects of the operations of 1915 may be performed by a beam pair component 1430 as described with reference to FIG. 14.

At 1920, the method may include outputting the downlink message using the first transmission resource associated with the first receive beam pointing direction based on the indication of the first receive beam pointing direction. The operations of 1920 may be performed in accordance with examples as disclosed herein. In some examples, aspects of the operations of 1920 may be performed by a transmission resource component 1435 as described with reference to FIG. 14.

The following provides an overview of examples of the present disclosure:

Aspect 1: An apparatus for wireless communications at a UE comprising a processor; memory coupled with the processor, the processor configured to transmit a report that indicates receive beam information for the UE, a first dimension of the report associated with one or more transmission resources of a network entity, and a second dimension of the report associated with one or more receive beam pointing directions at the UE; receive, based at least in part on the report, an indication of a first receive beam pointing direction of the one or more receive beam pointing directions for a downlink message for the UE, the first receive beam pointing direction associated with a first transmission resource of the one or more transmission resources; and receive the downlink message using a receive beam associated with the first receive beam pointing direction based at least in part on the indication of the first receive beam pointing direction.

Aspect 2: The apparatus of aspect 1, wherein the processor is further configured to: receive an indication of a total quantity of entries associated with the first dimension of the report and a total quantity of entries associated with the second dimension of the report, wherein the report is in accordance with the indication.

Aspect 3: The apparatus of aspect 2, wherein the total quantity of entries associated with the first dimension is based at least in part on one or more channel measurement resources, one or more virtual resources, or a combination thereof.

Aspect 4: The apparatus of any of aspects 1 through 3, wherein the processor is further configured to: transmit an indication of a capability of the UE to report the report, the capability indicating a quantity of entries associated with the second dimension of the report.

Aspect 5: The apparatus of any of aspects 1 through 3, wherein the processor is further configured to: transmit an indication of a capability of the UE to report the report, the capability indicating a quantity of non-zero values associated with the one or more receive beam pointing directions in the report.

Aspect 6: The apparatus of any of aspects 1 through 3, wherein the processor is further configured to: transmit an indication of a capability of the UE to report the report, the capability indicating a quantity of non-zero values associated with the one or more receive beam pointing directions per transmission resource.

Aspect 7: The apparatus of any of aspects 1 through 6, wherein to transmit the report, the processor is further configured to: transmit one or more non-zero values associated with the one or more receive beam pointing directions in the report, wherein the one or more non-zero values indicate one or more preferred receive beam pointing directions associated with the one or more transmission resources of the network entity.

Aspect 8: The apparatus of aspect 7, wherein the processor is further configured to: transmit an indication of positions of each of the one or more non-zero values in the report, wherein the positions are indicated via one of a bitmap, a combinatorial index, or an index associated with each of the one or more receive beam pointing directions.

Aspect 9: The apparatus of any of aspects 7 through 8, wherein the one or more non-zero values indicate a beam width associated with the one or more preferred receive beam pointing directions, a beamforming gain associated with the one or more preferred receive beam pointing directions, or both.

Aspect 10: The apparatus of any of aspects 7 through 8, wherein a quantity of non-zero values associated with the one or more receive beam pointing directions is fixed per transmission resource.

Aspect 11: The apparatus of aspect 10, wherein the processor is further configured to: receive an indication of the quantity of non-zero values associated with the one or more receive beam pointing directions per transmission resource.

Aspect 12: The apparatus of any of aspects 7 through 11, wherein a quantity of non-zero values associated with the one or more receive beam pointing directions is fixed for the report.

Aspect 13: The apparatus of aspect 12, wherein the processor is further configured to: receive an indication of the quantity of non-zero values associated with the one or more receive beam pointing directions in the report.

Aspect 14: The apparatus of any of aspects 1 through 13, wherein to transmit the report, the processor is further configured to: transmit, via a first CSI message, a quantity of the one or more receive beam pointing directions at the UE.

Aspect 15: The apparatus of any of aspects 1 through 13, wherein to transmit the report, the processor is further configured to: transmit, via a first CSI message, a quantity of non-zero values associated with the one or more receive beam pointing directions per transmission resource.

Aspect 16: The apparatus of any of aspects 1 through 13, wherein to transmit the report, the processor is further configured to: transmit, via a first CSI message, a quantity of non-zero values associated with the one or more receive beam pointing directions in the report.

Aspect 17: The apparatus of any of aspects 14 through 16, wherein to transmit the report, the processor is further configured to: transmit, via a second CSI message and in accordance with the first CSI message, one or more non-zero values in the report.

Aspect 18: The apparatus of any of aspects 14 through 16, wherein to transmit the report, the processor is further configured to: transmit, via a second CSI message and in accordance with the first CSI message, indexes associated with each of the one or more non-zero values.

Aspect 19: The apparatus of any of aspects 17 through 18, wherein the one or more non-zero values indicate preferred receive beam pointing directions at the UE associated with transmission resources of the network entity.

Aspect 20: The apparatus of any of aspects 1 through 19, wherein to receive the first receive beam pointing direction, the processor is further configured to: receive, via the indication, a multi-dimensional index associated with the report, wherein a first dimension of the multi-dimensional index indicates the first transmission resource of the one or more transmission resources of the network entity and a second dimension of the multi-dimensional index indicates the first receive beam pointing direction of the one or more or more receive beam pointing directions at the UE.

Aspect 21: The apparatus of any of aspects 1 through 20, wherein to transmit the report, the processor is further configured to: transmit one or more non-zero values associated with the one or more receive beam pointing directions at the UE for a single transmission resource of the network entity based at least in part on the one or more non-zero values associated with the one or more receive beam pointing directions being equal for each transmission resource of the one or more transmission resources.

Aspect 22: The apparatus of any of aspects 1 through 21, wherein the indication of the first receive beam pointing direction comprises a single dimensional index associated with the report that indicates the first receive beam pointing direction.

Aspect 23: The apparatus of any of aspects 1 through 22, wherein the indication of the first receive beam pointing direction comprises a CSI report setting identification, a slot identification associated with a transmission slot of the report, or both.

Aspect 24: The apparatus of any of aspects 1 through 23, wherein the report comprises a multi-dimensional report.

Aspect 25: An apparatus for wireless communications at a network entity comprising a processor; memory coupled with the processor, the processor configured to obtain a report that indicates receive beam information for a UE, a first dimension of the report associated with one or more transmission resources of the network entity, and a second dimension of the report associated with one or more receive beam pointing directions for the UE; output, based at least in part on the report, an indication of a first receive beam pointing direction of the one or more receive beam pointing directions for use in a downlink message for the UE, the first receive beam pointing direction associated with a first transmission resource of the one or more transmission resources; and output the downlink message using the first transmission resource associated with the first receive beam pointing direction based at least in part on the indication of the first receive beam pointing direction.

Aspect 26: The apparatus of aspect 25, wherein the processor is further configured to: obtain the first receive beam pointing direction based at least in part on a beam prediction procedure and on the report, wherein the outputted indication of the first receive beam pointing direction is in accordance with the obtained first receive beam pointing direction.

Aspect 27: The apparatus of aspect 26, wherein the beam prediction procedure is based at least in part on a machine learning model.

Aspect 28: The apparatus of any of aspects 25 through 27, wherein the processor is further configured to: output an indication of a total quantity of entries associated with the first dimension of the report and a total quantity of entries associated with the second dimension of the report, wherein the report is in accordance with the indication.

Aspect 29: The apparatus of aspect 28, wherein the total quantity of entries associated with the first dimension is based at least in part on one or more channel measurement resources, one or more virtual resources, or a combination thereof.

Aspect 30: The apparatus of any of aspects 25 through 29, wherein the processor is further configured to: obtain an indication of a capability of the UE to report the report, wherein the capability indicates a quantity of entries associated with the second dimension of the report.

Aspect 31: The apparatus of any of aspects 25 through 29, wherein the processor is further configured to: obtain an indication of a capability of the UE to report the report, wherein the capability indicates a quantity of non-zero values associated with the one or more receive beam pointing directions in the report.

Aspect 32: The apparatus of any of aspects 25 through 29, wherein the processor is further configured to: obtain an indication of a capability of the UE to report the report, wherein the capability indicates a quantity of non-zero values associated with the one or more receive beam pointing directions per transmission resource.

Aspect 33: The apparatus of any of aspects 25 through 32, wherein to obtain the report, the processor is further configured to: obtain one or more non-zero values associated with the one or more receive beam pointing directions in the report, wherein the one or more non-zero values indicate one or more preferred receive beam pointing directions associated with the one or more transmission resources of the network entity.

Aspect 34: The apparatus of aspect 33, wherein the processor is further configured to: obtain an indication of positions of each of the one or more non-zero values in the report, wherein the positions are indicated via one of a bitmap, a combinatorial index, or an index associated with each of the one or more receive beam pointing directions.

Aspect 35: The apparatus of any of aspects 33 through 34, wherein the one or more non-zero values indicate a beam width associated with the one or more preferred receive beam pointing directions, a beamforming gain associated with the one or more preferred receive beam pointing directions, or both.

Aspect 36: The apparatus of any of aspects 33 through 35, wherein a quantity of non-zero values associated with the one or more receive beam pointing directions is fixed per transmission resource.

Aspect 37: The apparatus of aspect 36, wherein the processor is further configured to: output an indication of the quantity of non-zero values associated with the one or more receive beam pointing directions per transmission resource.

Aspect 38: The apparatus of any of aspects 33 through 37, wherein a quantity of non-zero values associated with the one or more receive beam pointing directions is fixed for the report.

Aspect 39: The apparatus of aspect 38, wherein the processor is further configured to: output an indication of the quantity of non-zero values associated with the one or more receive beam pointing directions in the report.

Aspect 40: The apparatus of any of aspects 25 through 39, wherein, to obtain the report, the processor is further configured to: obtain, via a first CSI message, a quantity of the one or more receive beam pointing directions at the UE.

Aspect 41: The apparatus of any of aspects 25 through 39, wherein, to obtain the report, the processor is further configured to: obtain, via a first CSI message, a quantity of non-zero values associated with the one or more receive beam pointing directions per transmission resource.

Aspect 42: The apparatus of any of aspects 25 through 39, wherein, to obtain the report, the processor is further configured to: obtain, via a first CSI message, a quantity of non-zero values associated with the one or more receive beam pointing directions in the report.

Aspect 43: The apparatus of any of aspects 40 through 42, wherein, to obtain the report, the processor is further configured to: obtain, via a second CSI message and in accordance with the first CSI message, one or more non-zero values in the report.

Aspect 44: The apparatus of any of aspects 40 through 42, wherein, to obtain the report, the processor is further configured to: obtain, via a second CSI message and in accordance with the first CSI message, indexes associated with each of the one or more non-zero values.

Aspect 45: The apparatus of any of aspects 40 through 44, wherein the one or more non-zero values indicate one or more preferred receive beam pointing directions at the UE associated with transmission resources of the network entity.

Aspect 46: The apparatus of any of aspects 25 through 45, wherein to output the indication of the first receive beam, the processor is further configured to: output, via the indication, a multi-dimensional index associated with the report, wherein a first dimension of the multi-dimensional index indicates the first transmission resource of the one or more transmission resources of the network entity and a second dimension of the multi-dimensional index indicates the first receive beam pointing direction of the one or more or more receive beam pointing directions at the UE.

Aspect 47: The apparatus of any of aspects 25 through 46, wherein, to obtain the report, the processor is further configured to: obtain one or more non-zero values associated with the one or more receive beam pointing directions at the UE for a single transmission resource of the network entity based at least in part on the one or more non-zero values associated with the one or more receive beam pointing directions being equal for each transmission resource of the one or more transmission resources.

Aspect 48: The apparatus of any of aspects 25 through 47, wherein the indication of the first receive beam pointing direction comprises a single dimensional index associated with the report that indicates the first receive beam pointing direction.

Aspect 49: The apparatus of any of aspects 25 through 48, wherein the indication of the first receive beam pointing direction comprises a CSI report setting identification, a slot identification associated with a transmission slot of the report, or both.

Aspect 50: A method for wireless communication at a UE, comprising: transmitting a report that indicates receive beam information for the UE, a first dimension of the report associated with one or more transmission resources of a network entity, and a second dimension of the report associated with one or more receive beam pointing directions at the UE; receiving, based at least in part on the report, an indication of a first receive beam pointing direction of the one or more receive beam pointing directions for a downlink message for the UE, the first receive beam pointing direction associated with a first transmission resource of the one or more transmission resources; and receiving the downlink message using a receive beam associated with the first receive beam pointing direction based at least in part on the indication of the first receive beam pointing direction.

Aspect 51: The method of aspect 50, further comprising: receiving an indication of a total quantity of entries associated with the first dimension of the report and a total quantity of entries associated with the second dimension of the report, wherein the report is in accordance with the indication.

Aspect 52: The method of aspect 51, wherein the total quantity of entries associated with the first dimension is based at least in part on one or more channel measurement resources, one or more virtual resources, or a combination thereof.

Aspect 53: The method of any of aspects 50 through 52, further comprising: transmitting an indication of a capability of the UE to report the report, the capability indicating a quantity of entries associated with the second dimension of the report.

Aspect 54: The method of any of aspects 50 through 52, further comprising: transmitting an indication of a capability of the UE to report the report, the capability indicating a quantity of non-zero values associated with the one or more receive beam pointing directions in the report.

Aspect 55: The method of any of aspects 50 through 52, further comprising: transmitting an indication of a capability of the UE to report the report, the capability indicating a quantity of non-zero values associated with the one or more receive beam pointing directions per transmission resource.

Aspect 56: The method of any of aspects 50 through 55, the transmitting comprising: transmitting one or more non-zero values associated with the one or more receive beam pointing directions in the report, wherein the one or more non-zero values indicate one or more preferred receive beam pointing directions associated with the one or more transmission resources of the network entity.

Aspect 57: The method of aspect 56, further comprising: transmitting an indication of positions of each of the one or more non-zero values in the report, wherein the positions are indicated via one of a bitmap, a combinatorial index, or an index associated with each of the one or more receive beam pointing directions.

Aspect 58: The method of any of aspects 56 through 57, wherein the one or more non-zero values indicate a beam width associated with the one or more preferred receive beam pointing directions, a beamforming gain associated with the one or more preferred receive beam pointing directions, or both.

Aspect 59: The method of any of aspects 56 through 58, wherein a quantity of non-zero values associated with the one or more receive beam pointing directions is fixed per transmission resource.

Aspect 60: The method of aspect 59, further comprising: receiving an indication of the quantity of non-zero values associated with the one or more receive beam pointing directions per transmission resource.

Aspect 61: The method of any of aspects 56 through 60, wherein a quantity of non-zero values associated with the one or more receive beam pointing directions is fixed for the report.

Aspect 62: The method of aspect 61, further comprising: receiving an indication of the quantity of non-zero values associated with the one or more receive beam pointing directions in the report.

Aspect 63: The method of any of aspects 50 through 62, the transmitting comprising: transmitting, via a first CSI message, a quantity of the one or more receive beam pointing directions at the UE.

Aspect 64: The method of any of aspects 50 through 62, the transmitting comprising: transmitting, via a first CSI message, a quantity of non-zero values associated with the one or more receive beam pointing directions per transmission resource.

Aspect 65: The method of any of aspects 50 through 62, the transmitting comprising: transmitting, via a first CSI message, a quantity of non-zero values associated with the one or more receive beam pointing directions in the report.

Aspect 66: The method of any of aspects 63 through 65, the transmitting comprising: transmitting, via a second CSI message and in accordance with the first CSI message, one or more non-zero values in the report.

Aspect 67: The method of any of aspects 63 through 65, the transmitting comprising: transmitting, via a second CSI message and in accordance with the first CSI message, indexes associated with each of the one or more non-zero values.

Aspect 68: The method of any of aspects 63 through 67, wherein the one or more non-zero values indicate preferred receive beam pointing directions at the UE associated with transmission resources of the network entity.

Aspect 69: The method of any of aspects 50 through 68, the receiving of the first beam pointing direction comprising: receiving, via the indication, a multi-dimensional index associated with the report, wherein a first dimension of the multi-dimensional index indicates the first transmission resource of the one or more transmission resources of the network entity and a second dimension of the multi-dimensional index indicates the first receive beam pointing direction of the one or more or more receive beam pointing directions at the UE.

Aspect 70: The method of any of aspects 50 through 69, the transmitting comprising: transmitting one or more non-zero values associated with the one or more receive beam pointing directions at the UE for a single transmission resource of the network entity based at least in part on the one or more non-zero values associated with the one or more receive beam pointing directions being equal for each transmission resource of the one or more transmission resources.

Aspect 71: The method of any of aspects 50 through 70, wherein the indication of the first receive beam pointing direction comprises a single dimensional index associated with the report that indicates the first receive beam pointing direction.

Aspect 72: The method of any of aspects 50 through 71, wherein the indication of the first receive beam pointing direction comprises a CSI report setting identification, a slot identification associated with a transmission slot of the report, or both.

Aspect 73: The method of any of aspects 50 through 72, wherein the report comprises a multi-dimensional report.

Aspect 74: A method of wireless communication at a network entity, comprising: obtaining a report that indicates receive beam information for a UE, a first dimension of the report associated with one or more transmission resources of the network entity, and a second dimension of the report associated with one or more receive beam pointing directions for the UE; outputting, based at least in part on the report, an indication of a first receive beam pointing direction of the one or more receive beam pointing directions for use in a downlink message for the UE, the first receive beam pointing direction associated with a first transmission resource of the one or more transmission resources; and outputting the downlink message using the first transmission resource associated with the first receive beam pointing direction based at least in part on the indication of the first receive beam pointing direction.

Aspect 75: The method of aspect 74, further comprising: obtaining the first receive beam pointing direction based at least in part on a beam prediction procedure and on the report, wherein the outputted indication of the first receive beam pointing direction is in accordance with the obtained first receive beam pointing direction.

Aspect 76: The method of aspect 75, wherein the beam prediction procedure is based at least in part on a machine learning model.

Aspect 77: The method of any of aspects 74 through 76, further comprising: outputting an indication of a total quantity of entries associated with the first dimension of the report and a total quantity of entries associated with the second dimension of the report, wherein the report is in accordance with the indication.

Aspect 78: The method of aspect 77, wherein the total quantity of entries associated with the first dimension is based at least in part on one or more channel measurement resources, one or more virtual resources, or a combination thereof.

Aspect 79: The method of any of aspects 74 through 78, further comprising: obtaining an indication of a capability of the UE to report the report, wherein the capability indicates a quantity of entries associated with the second dimension of the report.

Aspect 80: The method of any of aspects 74 through 78, further comprising: obtaining an indication of a capability of the UE to report the report, wherein the capability indicates a quantity of non-zero values associated with the one or more receive beam pointing directions in the report.

Aspect 81: The method of any of aspects 74 through 78, further comprising: obtaining an indication of a capability of the UE to report the report, wherein the capability indicates a quantity of non-zero values associated with the one or more receive beam pointing directions per transmission resource.

Aspect 82: The method of any of aspects 74 through 81, the obtaining comprising: obtaining one or more non-zero values associated with the one or more receive beam pointing directions in the report, wherein the one or more non-zero values indicate one or more preferred receive beam pointing directions associated with the one or more transmission resources of the network entity.

Aspect 83: The method of aspect 82, further comprising: obtaining an indication of positions of each of the one or more non-zero values in the report, wherein the positions are indicated via one of a bitmap, a combinatorial index, an index associated with each of the one or more receive beam pointing directions, or a combination thereof.

Aspect 84: The method of any of aspects 82 through 83, wherein the one or more non-zero values indicate a beam width associated with the one or more preferred receive beam pointing directions, a beamforming gain associated with the one or more preferred receive beam pointing directions, or both.

Aspect 85: The method of any of aspects 82 through 84, wherein a quantity of non-zero values associated with the one or more receive beam pointing directions is fixed per transmission resource.

Aspect 86: The method of aspect 85, further comprising: outputting an indication of the quantity of non-zero values associated with the one or more receive beam pointing directions per transmission resource.

Aspect 87: The method of any of aspects 82 through 86, wherein a quantity of non-zero values associated with the one or more receive beam pointing directions is fixed for the report.

Aspect 88: The method of aspect 87, further comprising: outputting an indication of the quantity of non-zero values associated with the one or more receive beam pointing directions in the report.

Aspect 89: The method of any of aspects 74 through 88, the obtaining comprising: obtaining, via a first CSI message, a quantity of the one or more receive beam pointing directions at the UE.

Aspect 90: The method of any of aspects 74 through 88, the obtaining comprising: obtaining, via a first CSI message, a quantity of non-zero values associated with the one or more receive beam pointing directions per transmission resource.

Aspect 91: The method of any of aspects 74 through 88, the obtaining comprising: obtaining, via a first CSI message, a quantity of non-zero values associated with the one or more receive beam pointing directions in the report.

Aspect 92: The method of any of aspects 89 through 91, the obtaining comprising: obtaining, via a second CSI message and in accordance with the first CSI message, one or more non-zero values in the report.

Aspect 93: The method of any of aspects 89 through 91, the obtaining comprising: obtaining, via a second CSI message and in accordance with the first CSI message, indexes associated with each of the one or more non-zero values.

Aspect 94: The method of any of aspects 89 through 93, wherein the one or more non-zero values indicate one or more preferred receive beam pointing directions at the UE associated with transmission resources of the network entity.

Aspect 95: The method of any of aspects 74 through 94, the outputting of the first beam pointing direction comprising: outputting, via the indication, a multi-dimensional index associated with the report, wherein a first dimension of the multi-dimensional index indicates the first transmission resource of the one or more transmission resources of the network entity and a second dimension of the multi-dimensional index indicates the first receive beam pointing direction of the one or more or more receive beam pointing directions at the UE.

Aspect 96: The method of any of aspects 74 through 95, the obtaining comprising: obtaining one or more non-zero values associated with the one or more receive beam pointing directions at the UE for a single transmission resource of the network entity based at least in part on the one or more non-zero values associated with the one or more receive beam pointing directions being equal for each transmission resource of the one or more transmission resources.

Aspect 97: The method of any of aspects 74 through 96, wherein the indication of the first receive beam pointing direction comprises a single dimensional index associated with the report that indicates the first receive beam pointing direction.

Aspect 98: The method of any of aspects 74 through 97, wherein the indication of the first receive beam pointing direction comprises a CSI report setting identification, a slot identification associated with a transmission slot of the report, or both.

Aspect 99: The method of any of aspects 74 through 98, wherein the report comprises a multi-dimensional report.

Aspect 100: An apparatus for wireless communication at a UE, comprising at least one means for performing a method of any of aspects 50 through 73.

Aspect 101: A non-transitory computer-readable medium storing code for wireless communication at a UE, the code comprising instructions executable by a processor to perform a method of any of aspects 50 through 73.

Aspect 102: An apparatus for wireless communication at a network entity, comprising at least one means for performing a method of any of aspects 74 through 99.

Aspect 103: A non-transitory computer-readable medium storing code the code comprising instructions executable by a processor to perform a method of any of aspects 74 through 99.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor; and
memory coupled with the processor, the processor configured to:
transmit a report that indicates receive beam information for the UE, a first dimension of the report associated with one or more transmission resources of a network entity, and a second dimension of the report associated with one or more receive beam pointing directions at the UE;
receive, based at least in part on the report, an indication of a first receive beam pointing direction of the one or more receive beam pointing directions for a downlink message for the UE, the first receive beam pointing direction associated with a first transmission resource of the one or more transmission resources; and
receive the downlink message via a receive beam associated with the first receive beam pointing direction based at least in part on the indication of the first receive beam pointing direction.

2. The apparatus of claim 1, wherein the processor is further configured to:
receive an indication of a total quantity of entries associated with the first dimension of the report and a total quantity of entries associated with the second dimension of the report, wherein the report is in accordance with the indication.

3. The apparatus of claim 2, wherein the total quantity of entries associated with the first dimension is based at least in part on one or more channel measurement resources, one or more virtual resources, or a combination thereof.

4. The apparatus of claim 1, wherein the processor is further configured to:
transmit an indication of a capability of the UE to report the report, wherein the capability indicates a quantity of entries associated with the second dimension of the report, a quantity of non-zero values associated with the one or more receive beam pointing directions in the report, a quantity of non-zero values associated with the one or more receive beam pointing directions per transmission resource, or a combination thereof.

5. The apparatus of claim 1, wherein, to transmit, the processor is configured to:
transmit one or more non-zero values associated with the one or more receive beam pointing directions in the report, wherein the one or more non-zero values indicate one or more preferred receive beam pointing directions associated with the one or more transmission resources of the network entity.

6. The apparatus of claim 5, wherein the processor is further configured to:
transmit an indication of positions of each of the one or more non-zero values in the report, wherein the positions are indicated via one of a bitmap, a combinatorial index, an index associated with each of the one or more receive beam pointing directions, or a combination thereof.

7. The apparatus of claim 5, wherein the one or more non-zero values indicate a beam width associated with the one or more preferred receive beam pointing directions, a beamforming gain associated with the one or more preferred receive beam pointing directions, or both.

8-11. (canceled)

12. The apparatus of claim 1, wherein, to transmit, the processor is configured to:
transmit, via a first channel state information message, a quantity of the one or more receive beam pointing directions at the UE, a quantity of non-zero values associated with the one or more receive beam pointing directions per transmission resource, a quantity of non-zero values associated with the one or more receive beam pointing directions in the report, or any combination thereof, and
transmit, via a second channel state information message and in accordance with the first channel state information message, one or more non-zero values in the report, indexes associated with each of the one or more non-zero values, or both, wherein the one or more non-zero values indicate preferred receive beam pointing directions at the UE associated with transmission resources of the network entity.

13. The apparatus of claim 1, wherein, to receive the first receive beam pointing direction, the processor is configured to:
receive, via the indication, a multi-dimensional index associated with the report, wherein a first dimension of the multi-dimensional index indicates the first transmission resource of the one or more transmission resources of the network entity and a second dimension of the multi-dimensional index indicates the first receive beam pointing direction of the one or more or more receive beam pointing directions at the UE.

14. The apparatus of claim 1, wherein, to transmit, the processor is configured to:
transmit one or more non-zero values associated with the one or more receive beam pointing directions at the UE for a single transmission resource of the network entity based at least in part on the one or more non-zero values associated with the one or more receive beam pointing directions being equal for each transmission resource of the one or more transmission resources.

15. The apparatus of claim 1, wherein the indication of the first receive beam pointing direction comprises a single dimensional index associated with the report that indicates the first receive beam pointing direction.

16. The apparatus of claim 1, wherein the indication of the first receive beam pointing direction comprises a channel state information report setting identification, a slot identification associated with a transmission slot of the report, or both.

17. The apparatus of claim 1, wherein the report comprises a multi-dimensional report.

18. An apparatus for wireless communications at a network entity, comprising:
a processor; and
memory coupled with the processor, the processor configured to:
obtain a report that indicates receive beam information for a user equipment (UE), a first dimension of the report associated with one or more transmission resources of the network entity, and a second dimension of the report associated with one or more receive beam pointing directions for the UE;
output, base at least in part on the report, an indication of a first receive beam pointing direction of the one or more receive beam pointing directions for use in a downlink message for the UE, the first receive beam pointing direction associated with a first transmission resource of the one or more transmission resources; and
output the downlink message via the first transmission resource associated with the first receive beam pointing direction based at least in part on the indication of the first receive beam pointing direction.

19. The apparatus of claim 18, wherein the processor is further configured to:
obtain the first receive beam pointing direction based at least in part on a beam prediction procedure and on the report, wherein the outputted indication of the first receive beam pointing direction is in accordance with the obtained first receive beam pointing direction.

20. The apparatus of claim 19, wherein the beam prediction procedure is based at least in part on a machine learning model.

21. The apparatus of claim 18, wherein the processor is further configured to:
output an indication of a total quantity of entries associated with the first dimension of the report and a total quantity of entries associated with the second dimension of the report, wherein the report is in accordance with the indication.

22. The apparatus of claim 21, wherein the total quantity of entries associated with the first dimension is based at least in part on one or more channel measurement resources, one or more virtual resources, or a combination thereof.

23. The apparatus of claim 18, wherein the processor is further configured to:
obtain an indication of a capability of the UE to report the report, wherein the capability indicates a quantity of entries associated with the second dimension of the report, a quantity of non-zero values associated with the one or more receive beam pointing directions in the report, a quantity of non-zero values associated with the one or more receive beam pointing directions per transmission resource, or a combination thereof.

24. The apparatus of claim 18, wherein, to obtain, the processor is configured to:
obtain one or more non-zero values associated with the one or more receive beam pointing directions in the report, wherein the one or more non-zero values indicate one or more preferred receive beam pointing directions associated with the one or more transmission resources of the network entity.

25-30. (canceled)
